(19) United States
(12) Patent Application Publication
(10) Pub. No.: US 2023/0280975 A1
(43) Pub. Date: Sep. 7, 2023

(54) Variable Format Floating Point Logic

(71) Applicant: Graphcore Limited, Bristol (GB)

(72) Inventors: Mrudula GORE, Bath (GB); Stephen FELIX, Bristol (GB); Simon Christian KNOWLES, Corston (GB)

(21) Appl. No.: 18/061,553

(22) Filed: Dec. 5, 2022

(30) Foreign Application Priority Data
Mar. 2, 2022 (GB) 2202881.5

(51) Int. Cl. G06F 7/487

(52) U.S. Cl. CPC G06F 7/4876

(57) ABSTRACT

Logic circuitry for multiplying floating point numbers is disclosed, comprising multiplication and addition logic. The multiplication logic includes first and second mantissa multiplying circuitry. The logic circuitry is configured to: in a first mode, determine a product of two values having a first number format, using sub-units of the first mantissa multiplying circuitry to calculate partial products of the mantissas, and using the addition logic to combine the partial products; in a second mode, determine a respective product of each of four pairs of values having a second number format, using the sub-units of the first mantissa multiplying circuitry to multiply the mantissas of the pairs; and in a third mode, determine products of each of a plurality of pairs of values having a third number format, using the second mantissa multiplying circuitry to generate a product for each pair.

### CROSS-REFERENCE TO RELATED APPLICATIONS

The present application claims priority to United Kingdom Patent Application No. GB2202881.5, filed Mar. 2, 2022, the disclosure of which is hereby incorporated herein by reference in its entirety.

### TECHNICAL FIELD

The present disclosure relates to logic circuitry configured to operate upon floating point numbers of different lengths. The logic circuitry may for example be included in a computer processor for executing arithmetic instructions.

### BACKGROUND

A processor is a device for executing sequences of machine code instruction. A given design of processor will be configured to be able to execute instructions from a certain predefined set of instruction types. This set is known as the instruction set of the processor. Each instruction type in the instruction set is defined by a respective opcode and zero or more operand fields. A program for a computer comprises a series of instructions for the processor to execute. This may be written in a high-level language and then compiled into instructions of the instruction set, or may be written directly in the instructions of the instruction set. The processor has access to a memory that stores programs for execution in the form of machine code instructions. The memory also contains values that may be operated on by the program, and space for the processor to store values calculated during execution of the program. The processor fetches instructions from the memory for execution. The processor may comprise a number of different kinds of sub-unit for executing different types of instruction. For example, the processor may comprise an integer arithmetic logic unit for performing integer arithmetic operations in response to arithmetic instruction types, a floating point arithmetic logic unit for performing floating point operations in response to floating point instruction types, and a load-store unit for performing memory access operations in response to load and store instruction types.

By way of example, in a reduced instruction set computer (RISC), the instruction set will comprise logic instructions (e.g. add, multiply, etc.) to be executed by one or more logic units, and separate load and store instructions to be executed by a load/store unit. A load instruction takes at least two operands: a source operand identifying a source memory address and an identifier specifying a destination register of the processor. When executed, the load instruction causes the load-store unit to load a value from the source address into the destination register. Logic instructions may take different numbers of operands depending on the type of instruction. For instance a logic instruction such as an add or multiply instruction may take three operands: two specifying two respective source registers in the register file, and one specifying a destination register in the register file. When executed, the logic instruction causes the appropriate logic unit, such an add or multiply unit to perform the relevant logic operation on the values in the specified source registers, and place the result in the specified destination register. The opcode of the instructions defines the type of operation to be performed, and therefore which logic unit is triggered to perform this operation. A store instruction can then be used to store a result from a register back to memory. A store instruction takes at least two operands: one specifying a source register of the processor, and one specifying a destination address in memory. When executed the store instruction causes the load-store unit to store the value in the specified source register to the destination memory address.

An instruction set may also include more specialised instruction types. Such an instruction type will perform a more complex or operation or compound operation, which is more complex than a simple load, store, add or multiply, etc. E.g. this could be a particular mathematical operation that is a combination of a plurality of constituent operations, such as a multiply-add- or multiply-accumulate (MAC). The whole compound operation will be triggered in response the execution of a single instance of a single machine code instruction of the type in question, defined by a single opcode. The same operation could be built from a combination of general purpose add and multiply instructions, or the like, but that would reduce the code density compared to using instructions of a more specialised instruction set.

A given storage element or data carrying medium of a processor, such a bus, register, or element of addressable memory, will typically have a certain defined bit width (e.g. architectural width), such as 8 bits, 16 bits or 32 bits. When a register or the like is used to represent a number, different subgroups of the bits at different positions within the register (i.e. different fields of the register) are used to represent different properties of the number format. E.g. in the simple example of a signed integer, the properties are sign and magnitude. Similar comments may apply to different fields formed from the lines of a bus, for example. The logic in the processing unit of the computer is configured to know which predetermined fields represent which property of the number format, and to process the bits of those fields accordingly. For instance, to represent a signed integer, the first (most significant) bit position in the register may be used to hold a sign bit representing the sign of the number, and the rest of the bits may be used to represent the magnitude of the number.

A floating point number format typically comprises three fields: i) a single-bit sign field for holding a sign bit, ii) an exponent field for holding a set of exponent bits representing an exponent, and iii) a mantissa field for holding a set of mantissa bits representing a mantissa (also called the significand). The format is a way of representing a binary number equal in value to (−1)\hat{ }S×(M+1)×2\hat{ }E-b, where S is the sign bit, M is the mantissa, E is the exponent and b is a bias (which could in principal be 0 in some systems, though conventionally is not). The bias is typically implicit, as are the base of 2 and the leading 1 before the decimal place. In some number formats the leading 1 is implicit unless all the bits of the mantissa are zero, in which case it becomes a leading 0.

The width of the mantissa field determines the precision of the number format, and the width of the exponent field along with any bias determines its range. Different system designers have selected floating point number formats having different sized mantissa and exponent fields. For instance, consider a 16-bit floating point number format. As a matter of notation the number of sign, exponent and mantissa bits of a given format may be expressed as sign:exponent:mantissa respectively. The IEEE standard is 1:5:10. Another format is known as DLFloat which has format 1:6:9. Another known as bfloat16 has format 1:8:7.

Multiplication of floating point values may be done by addition of the exponents and multiplication of the mantissas. Addition of floating point values is more complex, because the mantissas may not be simply added without reference to the exponents. For example, to add A=1×2\hat{ }3 and B=2×2\hat{ }4, it would not be correct to simply add the mantissas 1 and 2. Instead, one of the floating point values must be rewritten so that each has the same exponent. For example, if A is rewritten as 0.5*2\hat{ }4, then A and B may be added together by adding the mantissas, giving 2.5×2\hat{ }4. Alternatively, it would be possible to rewrite B as 4×2\hat{ }3. In a computer processor, these numbers are represented in binary. This means that “rewriting” floating point value A to have the same exponent as B simply requires shifting the bits of the mantissa of A in the direction of least significance. By convention, when written in human-readable form bits from most to least significant are written from left to right, and by analogy the bits of a binary value are often also described as such when describing bit significance in a computer or logic circuitry or such like (this does not imply anything about the physical orientation of the bit positions in the logic). So with the bits of the mantissa described as having the most significant bit on the “right-hand” side, then shifting each bit of the mantissa one place to the left allows the floating point value to be “rewritten” with an exponent one digit higher, i.e. with the same exponent as B. Likewise, all of the bits of the mantissa of B could be right-shifted by one space, with a 0 inserted to fill the least significant bit. However, this could result in losing the rightmost (i.e. most significant) digit of the mantissa of B. It is therefore conventional to leave the mantissa with the largest exponent unshifted, and to shift the other mantissas so that the floating points can be rewritten in terms of the largest exponent.

Multiplication of floating point values, and addition of floating point values are both processes that generate further, resultant floating point values. As discussed in the process of addition, floating point values may be expressed in different ways by shifting the digits of the mantissa and incrementing or decrementing the exponent by the same amount. However, these formats may have different degrees of precision. To give an example in decimal format, it is possible to represent a number C as 1.23456×10\hat{ }−2, or 0.01234×10\hat{ }0. Both these representations use the same number of digits for the mantissa and the exponent, but the first number is more accurate. Normalisation is the process of optimising the precision of representation of a floating point number for a given number of mantissa and exponent bits. In the above example, the greater precision was achieved by eliminating the leading zeros from the mantissa. Normalisation of floating point values is also done by eliminating the leading zeros. When floating points are represented in binary, this means that the floating point must start with a 1. Since a normalised float always starts with a 1, this 1 is often taken as implicit, and is not included in the representation of the mantissa in the normalised format.

Application-specific processors are processors tailored to a specific application. For example, these may be graphics processing units (GPUs) tailored to rendering of graphics, or Al-accelerator processors tailored to machine learning applications. One way in which processors may be tailored to an application is to include specialised instruction types in the instruction set of the processor. These specialised instruction types perform more complex operations than a simple load, store, add, multiply, etc., as discussed previously.

Multiply-add and multiply-accumulate instructions are particularly useful in vector and matrix manipulation. For example, calculating the dot product (also known as the inner product) between two vectors a₁, a₂, . . . an and b₁, b₂, . . . bₙ requires computing the pairwise multiplications a₁*b₁, a₂*b₂ . . . , an bₙ, and then accumulating these products into a final value.

Vector and matrix manipulation is used in many fields of application of computing, one of which is in the field of neural networks. Neural networks take as input a vector, and produce some output. The input vector is processed by convolution with a series of weighting factors, which are dynamically adjusted during training on a training dataset. Once training is complete and the weights have been determined, the neural network may be used to predict an appropriate output for a given input vector, by convolving the vector with the weighting factors. The weighting may be done in several layers.

Different precision number formats may be more or less appropriate to different applications or different uses within a given application. For example, weightings in neural networks are approximate values that are tuned to fit training data. A large number of significant figures may not be necessary to describe the weighting values, because it is unnecessary to record the number to a greater precision than the estimated error bounds on the number. At other stages in the machine learning algorithm however, a higher precision may be useful.

### SUMMARY

It is desirable for a processor to provide dedicated multiplication circuitry, such as multiply-add or multiply-accumulate circuitry, for floating point processing. It is also desirable for such multiplication operations to be able to process different lengths of floating point values. However, providing separate dedicated multiply-accumulate circuitry for each supported floating point number length is costly in terms of silicon footprint. Therefore it may be desirable to share common logic circuitry such as multiplication or multiply-add logic between different lengths of floating points. However, it is also recognized herein that it may in fact still be better for some dedicated logic circuitry to be included that is specific to a particular floating point number format, as the footprint of the extra wiring and multiplexing circuitry required to adapt some regions of logic circuitry designed for one format to accommodate another format may outweigh the saving. In other words, duplicating logic circuitry for different number formats can actually sometimes actually incur a lower silicon footprint than trying to share common logic circuitry between number formats.

According to a first aspect disclosed herein, there is provided logic circuitry for multiplying floating point numbers, each floating point number comprising a mantissa and an exponent. The logic circuitry comprises multiplication logic and addition logic. The multiplication logic includes: first mantissa multiplying circuitry comprising at least four multiplier sub-units, second mantissa multiplying circuitry separate from the first mantissa multiplying circuitry. The addition logic comprises at least first product addition circuitry. The logic circuitry is configured so as: I) in a first mode, to perform a multiplication to determine a product of two input values as an output value, each of the two input values having a first, higher precision number format, wherein the multiplication in the first mode includes: using each of the sub-units of the first mantissa multiplying circuitry to calculate a different partial product of the mantissas of the two input values, and using the first product addition circuitry to determine the product of the two input values by combining the partial products of the mantissas; II) in a second mode, to perform multiplications to determine a respective product of each of four pairs of input values, each input value of the four pairs having a second, intermediate precision number format, wherein the multiplications in the second mode include: using each of the multiplication sub-units of the first mantissa multiplying circuitry to multiply the mantissas of a different respective one of the pairs to calculate a respective mantissa product; and III) in a third mode, to perform multiplications to determine a respective product of each of a plurality of pairs of input values, each input value of said plurality of pairs having a third, lower precision number format, wherein the multiplications in the third mode include: using the second mantissa multiplying circuitry to multiply the mantissas of each pair to generate a respective mantissa product for each pair.

The disclosed circuitry is based on the realization that, for a processor capable of operating with floating point values of at least three distinct length formats it is possible to reuse the multiplication circuitry, such that either a) in a first mode, the circuitry calculates one multiplication of mantissas of a first, higher precision format by carrying out at least four partial product calculations and then summing the partial products, or b) in a second mode, the same circuitry carries out at least four multiplications of mantissas of a second, intermediate precision format. In the second mode the same circuitry may optionally also be used to sums the results of the four multiplications as part of a multiply-add operation. Sharing logic circuitry in this way reduces the silicon footprint compared to including completely separate, dedicated circuitry for both variants. Note that where four sub-units are referred to here for determining four products in the second mode or four partial products in the first mode, this does not limit to only four and more generally there could be any square number of multiplier sub-units, comprising at least four multiplier sub-units, for determining a corresponding number of partial products in the first mode, or the same number of products (of the same number of respective pairs of input values) in the second mode. E.g. the circuitry could equally be configured to calculate nine partial products based on dividing each of the first mode mantissas into three portions. This circuitry would then be capable of calculating nine multiplications in the second mode.

By way of example, the first format could be 32-bit format and the second format could be a 16-bit format. In some embodiments the mantissa of the first format is twice the length of the mantissa of the second format, e.g. 24-bits in the first format and 12 bits in the second. Four multiplier sub-units may be provided in these embodiments, each to multiply a different combination of 12-bit halves of the 24-bit mantissas in the 32-bit format in the first mode, or a different respective pair of 12-bit mantissas of the 16-bit format in the second mode. In other embodiments, the mantissa of the first format is 12 bits in the first mode, and 8 bits in the second mode.

However, it is recognized herein that the multiplexing circuitry that would be required to adapt this circuitry to also be capable of processing floating point values of a third, lower precision format (e.g. eights bits long with 3 or 4 bit mantissas) has such a high silicon footprint compared to the simplicity of the circuitry required multiply such short mantissas, that the overall silicon footprint of the unit is actually reduced by providing separate mantissa multiplication circuitry for the third format.

In embodiments, the logic circuitry may be configured so as in the second mode, to use the addition logic to determine a sum of the products of the four pairs as the output value.

In embodiments, the logic circuitry may be configured so as in the third mode, to use the addition logic to determine a sum of the products of the plurality of pairs as the output value.

In embodiments, the addition logic may comprise exponent sorting circuitry, and the logic circuitry may be configured so as: in the second mode, to add a set of second addends comprising at least the products of the four pairs, including by: using the exponent sorting circuitry to sort the exponents of the second addends, in order to align the mantissas of the second addends according to bit significance and add the aligned mantissas; and in the third mode, to add a set of third addends comprising at least the products of said plurality of pairs, including by: using at least part of the same exponent sorting circuitry as used in the second mode to sort the exponents of the third addends, in order to align the mantissas of the third addends according to bit significance and add the aligned mantissas.

Adding floating point values involves comparing the exponents of the values being added (the “addends”), in order shift all but one of the values' mantissas (typically the most significant) by the appropriate amounts and then add the shifted results; as well as to determine the largest exponent and make that the exponent of the summed value. It is recognized herein that the relatively small set of addends in the first mode can be handled by a relatively small, simple dedicated circuit, especially in the simple case where it just involves comparing the exponents of two addends. However in the second and third modes, which in embodiments involve a larger set of addends, the exponent comparing circuitry will need to comprise more complex exponent sorting circuitry for sorting between the exponents of three or more (e.g. eight) addends. There is still scope for sharing such exponent circuitry between the second and third modes.

It may be desirable to provide a small, separate exponent comparing circuit for the first mode, since this will have a lower power consumption than the more complex sorting circuitry, and so in the first mode the sorting circuitry of the second and third modes can be switched off to save power. Thus by providing a separate exponent comparing circuit, power consumption can be reduced with only a small extra cost in silicon footprint.

Alternatively however, the logic circuitry may be configured so as in the first mode, to add a set of first addends comprising the output value and at least one other value, including by: using at least part of the same exponent sorting circuitry as used in the second and third modes to sort the exponents of the first addends, in order to align the mantissas of the first addends according to bit significance and add the aligned mantissas.

According to a second aspect disclosed herein, there is provided value comparing circuitry, configured to take as input a plurality of values. The plurality of values being divided among at least a first group of values and a second group of values. The value comparing circuitry comprises first comparing circuitry, configured to determine the largest value in the first group, and for each other value in the first group to determine the difference between that other value and the largest value in the first group. The value comparing circuitry further comprises second comparing circuitry, which is configured to determine the largest value in the second group, and for each other value in the second group to determine the difference between that other value and the largest value in the second group. The value comparing circuitry also comprises third comparing circuitry, first difference calculating circuitry, second difference calculating circuitry, and multiplexing circuitry. The third comparing circuitry is configured to output an indication of whether the largest value in the first group is larger than the largest value in the second group. The first difference calculating circuitry is configured to determine the difference between each value in the first group and the largest value in the second group. The second difference calculating circuitry is configured to determine the difference between each value of the second group and the largest value in the first group. The multiplexing circuitry is configured so that when the indication is that the largest value in the first group is larger than the largest value in the second group, the multiplexing circuitry outputs the differences from the first comparing circuitry and the second difference calculating circuitry. In contrast, when the indication is that the largest value in the first group is not larger than the largest value in the second group, the multiplexing circuitry outputs the differences from the second group comparing circuitry and the first difference calculating circuitry.

Advantageously, this value comparing circuitry provides a balance between silicon footprint and speed, allowing many calculations to be done in parallel without significantly increasing the silicon footprint of the value comparing circuitry.

The second aspect may be used to compare exponent values as part of the logic circuitry of the first aspect. The second aspect may be used to further process values output from the logic circuitry of the first aspect. However, the second aspect may also be used independently of the first aspect. For example, the second aspect may be used for exponent comparing as part of a process of addition of floating point numbers, performed using alternative circuitry to the logic circuitry of the first aspect, or the second aspect may be used to compare values in a process unconnected to floating point addition. For example, the second aspect may be used to compare values to determine the difference in the price of a product at different supermarkets. Alternative uses for these aspects will be apparent to the skilled reader.

### BRIEF DESCRIPTION OF THE DRAWINGS

For a better understanding of embodiments disclosed herein and to show how embodiments may be put into effect, reference is made, by way of example only, to the accompanying drawings in which:

FIG. 1 is a schematic block diagram of logic circuitry for performing multiplication in three different number formats in accordance with the present disclosure;

FIG. 2 is a schematic block diagram of logic circuitry comprising at least one multiplication unit and at least one addition unit in accordance with embodiments of the present disclosure;

FIG. 3 is a schematic block diagram of a multiplication unit for performing multiplication or multiply-add operations, depending on number format, in accordance with embodiments disclosed herein;

FIG. 4 is a schematic block diagram of an addition unit for implementing at least part of the addition in a multiply-add or multiply-accumulate operation in accordance with embodiments disclosed herein,

FIG. 5 is a schematic illustration of an example of a multiply-accumulate operation that may be performed on values of a first, higher-precision number format in accordance with embodiments disclosed herein;

FIG. 6 is a schematic illustration of an example of a multiply-accumulate operation that may be performed on values of a second, intermediate-precision number format in accordance with embodiments disclosed herein;

FIG. 7 is a schematic illustration of an example of a multiply-accumulate operation that may be performed on values of a third, lower-precision number format in accordance with embodiments disclosed herein;

FIG. 8 schematically illustrates how the multiplication of the mantissas may be performed in the example of FIG. 5;

FIG. 9 schematically illustrates how comparing of the exponents may be performed in the example of FIG. 5;

FIG. 10 schematically illustrates how the multiplication of the mantissas may be performed in the example of FIG. 6;

FIG. 11 schematically illustrates how comparing of the exponents may be performed in the examples of FIGS. 6 and 7;

FIG. 12 schematically illustrates how the multiplication of the mantissas may be performed in the example of FIG. 7.

FIG. 13a schematically illustrates how comparing of the exponents may be performed in the examples of FIGS. 6 and 7.

FIG. 13b schematically illustrates how comparing of the exponents may be performed in the examples of FIGS. 6 and 7.

FIG. 14 is a schematic block diagram of a comparing unit for implementing the operations performed in the examples of FIG. 13a.

### DETAILED DESCRIPTION OF EMBODIMENTS

Examples in the following will be described in terms of three number formats: a 32-bit floating point format, which may be referred to herein as “FP32” for short; a 16-bit floating point number format, which may be referred to herein as “FP16” for short; and an 8-bit floating point number format which may be referred to herein as “FP8” for short. However this is not limiting, and more generally any reference to these number formats could be replaced with a first, higher precision number format (having a first, higher overall length and first, higher number of mantissa bits); a second, intermediate precision number format (having a second, intermediate overall length and second, intermediate number of mantissa bits); and a third, lower precision number format (having a third, lower overall length and a third, lower number of mantissa bits). In the case of FP32, FP16 and FP8; the first, 32-bit number format may have 24 mantissa bits; the second, 16-bit number format may have 12 mantissa bits; and the third, 8-bit number format has 2, 3 or 4 mantissa bits. However again this is not limiting and FP32, FP16 and/or FP8 with different numbers of mantissa bits are also possible, as long as the mantissa of the FP32 (or first) number format is longer (higher precision) than the FP16 (or second) number format, which in turn is longer than the mantissa of the FP8 (or third) number format. In some embodiments, the mantissa of the second format is half the size of the mantissa of the first format. In some embodiments, the mantissa of the first format is 12 bits in length. In some embodiments, the mantissa of the second format is 8 bits in length. Also, each number format preferably has exactly one sign bit. However, in some embodiments the exponent of the second format is 8 bits in length, and the second format has no sign bit.

In embodiments the disclosed logic may be part of the arithmetic logic of a processor, arranged to perform an operation comprising at least a multiplication of floating point numbers in response to one or more machine code instructions—preferably in response to the individual opcode of a single machine code instruction, i.e. an atomic operation. However this is not limiting and more generally, any of the logic designs herein could be used in any form of device for performing floating point operations, whether in a programmable processor, or in fixed function hardware, or in configurable or reconfigurable hardware such as a PGA (programmable gate array) or FPGA (field programmable gate array).

In embodiments, the operation in question may be a compound operation involving a multiply and at least one other constituent operation, such as an add. In embodiments the compound operation may be a multiply-add or multiply accumulate. In the latter case, the operation adds the currently calculated product from the current operation (or an intermediate sum of that product and one or more other values) and adds it to an accumulator value accumulated in a register, the accumulator value being the result of one or more previous instances of the same operation (e.g. in response to execution of one or more previous instances of the same machine code instruction). The new result is then written back to the same register, overwriting the previous accumulator value, and becomes the new accumulator value. In embodiments, the disclosed logic circuitry may be implemented as part of a unit designed for performing matrix products, such as in an application specific such as an Al accelerator processor.

In whatever context implemented, the presently disclosed logic share mantissa multiplying circuitry between FP32 and FP16 but not with FP8. However embodiments may share exponent sorting circuitry between at least FP16 and FP8. It is recognized herein that introducing an FP8 mode should not necessarily just rely on the same principle as sharing circuitry between FP32 and FP16 modes. With FP32/16 hardware sharing, in embodiments there may be dedicated exponent pipelines, whereas the mantissa pipeline may be shared. Whereas when an FP8 mode is introduced, it is recognized herein that it may be desirable to introduce a dedicated mantissa pipeline for FP8, though in embodiments an at least partially shared exponent pipeline. The reason is that in the FP8 format, the mantissa field is only a small size (perhaps only 2 or 3 bits) which is too small to be worth incurring the complexity of multiplexing to share the mantissa multiplying circuitry in the mantissa pipeline. It is actually cheaper in terms of complexity just to give each FP8 operation its own dedicated multiplier. However the exponent fields of the FP8 format may be larger, e.g. 4 or 5 bits, and here it may be worth including multiplexing to save on the duplication of hardware.

To multiply the 24-bit mantissas of FP32 (for example), multiplication logic may have four individual multiplier sub units and an adder. If a number A is divided into higher and lower significance 12-bit portions AhAl, and B is BhBl, then A*B=Ah*Bh+Ah*Bl+Al*Bh+Al*Bl. Each of the terms on the right hand side of this expression may be referred to as a partial product (not that for the present purposes, “partial product” does not limit to the partial product of individual digits, but rather any sized portions of a mantissa). These four partial products can be determined in parallel by the four multiplier sub-units, and added by the added to get the resulting full product. The multiplication could even be broken down into a larger number of smaller partial products to be dealt with by a larger number of multiplier sub-units.

The four (or more) multiplier sub-units can also be used, in another mode, to perform (at least) four parallel multiplications of a smaller number format such as FP16, e.g. having 12 mantissa bits per input value. Optionally the adder designed for adding the partial products in the FP32 mode could also be re-used to add the four individual products in the FP16 mode, Alternatively or additionally, the logic may also comprise further addition circuitry in order to sum the product from the FP32 or the four products from the FP16 mode with one or more further values, e.g. the output of another similar multiplication unit, and/or the value in an accumulator register.

In the addition of floating point numbers, dealing with the exponents involves comparing them in order to determine which is the largest, then right shifting the mantissa of the other addend value(s) by the appropriate amount.

Between FP32 and FP16 modes, the multipliers and optionally adder may be re-used to do either one FP32 multiplication, or four FP16 multiplications and optionally add the results. But FP32 and FP16 may be given their own exponent handling circuitry. Comparing the exponents of the two input values in a single FP32 multiplication can be done very efficiently. But for FP16, it is required to compare each of the four exponents with each other, which involves some more complex dedicated sorting circuitry.

It would also be desirable to provide a mode which can perform multiple (e.g. eight) FP8 multiplications (and in embodiments add the results). As disclosed herein, in this case it is in fact preferably not share the multipliers of the FP32 and FP16 operations, as the small (e.g. 2-3 bit) mantissa of FP8 means that the multiplexing complexity outweighs the benefit of sharing. But in embodiments, the exponent sorting circuitry may be shared between the FP16 and FP8 operations.

Thus in embodiments, there is provide a processor or other such logic which can perform at least 32, 16 or 8-bit floating point multiplication operations (or more generally any three different size number formats), where mantissa multiplication circuitry but not exponent comparing circuitry is shared between the two larger number formats (but not with the smaller number format); and/or the multi-way exponent comparing circuitry is shared between the two smaller number formats (but in embodiments not with the larger number format).

In embodiments there may be provided: matrix product unit or other such logic unit for performing FP32, FP16 and FP8 computations, the unit comprising:
a. one unit for multiplying one pair of FP32 numbers or 4 pairs of FP16 numbers or 8 pairs of FP8 numbers;
b. one unit for accumulating these products (from a);
c. multiplexing circuitry arranged to re-use the FP32 datapath pipeline for either the FP16 or FP8 operations such that
   FP32 and FP16 mantissa calculations are done using common circuitry,
   FP16 and FP8 exponent calculations are done using common circuitry; and
d. multiplexing circuitry to enable reuse of same accumulation hardware irrespective of input or output number format.

Here the FP32:FP16:FP8 vector ratio is 1:4:8.

Further embodiments may apply a factor of 2. Hence in embodiments there may be provided a matrix product unit or other such logic unit for performing FP32, FP16 and FP8 computations, the unit comprising:
a. one unit for multiplying two pairs of FP32 numbers or 8 pairs of FP16 numbers or 16 pairs of FP8 numbers;
b. one unit for accumulating these products (from a);
c. multiplexing circuitry arranged to re-use the FP32 datapath pipeline for either the FP16 or FP8 operations such that
   FP32 and FP16 mantissa calculations are done using common circuitry, and
   FP16 and FP8 exponent calculations are done using common circuitry; and
d. multiplexing circuitry to enable reuse of same accumulation hardware irrespective of input or output number format.

In yet further alternative embodiments, FP32, FP16 and FP8 exponent calculations may share common circuitry.

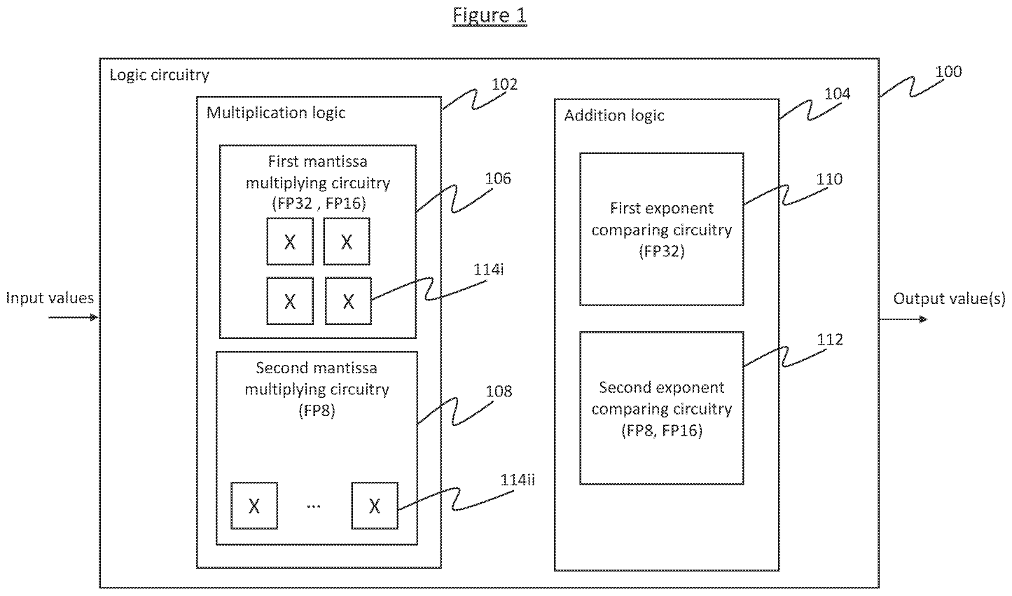

More generally, FIG. 1 shows logic circuitry 100 in accordance with embodiments disclosed herein. The logic circuitry 100 may for example take the form of an arithmetic logic unit such as a multiply unit, multiply-add unit or multiply-accumulator unit in a processor, such as an Al accelerator processor. The logic circuitry 100 is configured to perform an operation comprising at least a multiplication operation. In embodiments the operation may comprise a multiply-add operation and/or a multiply-accumulate operation. In embodiments the logic is implemented in a processor and is triggered to perform the operation in response to execution of one or more specific machine code instructions from the processor's instruction set—preferably in response to an individual machine code instruction. However in alternative embodiments the logic circuitry 100 could instead be used as part of a non-programmable, fixed function hardware circuit.

The logic circuitry 100 is arranged to receive a plurality of input values per operation, and to at least multiply together the values to produce an output value. In embodiments, the logic circuitry 100 may also add the output value of the multiplication to one or more other values, such as the output of another constituent multiply operation performed by the same logic 100 in the same operation, or a value from an accumulator register placed in the accumulator register by the same logic in a previous instance of the operation.

The logic circuitry 100 is operable in at least three different modes: a first, higher precision mode which by way of example will be taken in the following to be a FP32 mode; a second, intermediate precision mode which by way of example will be taken in the following to be a FP16 mode; and a third, lower precision mode which by way of example will be taken in the following to be a FP8 mode.

In the FP32 mode, the logic circuitry 100 receives at least one pair of input values, each of the pair of input values being a FP32 value having the FP32 (or first) number format. In the FP16 mode, the logic circuitry 100 receives at least four pairs of input values, each of the values of the four pairs being a FP16 value having the FP32 (or second) number format. In the FP8 mode, the logic circuitry receives a plurality (e.g. at least eight) pairs of values, each of the values this plurality of pairs being a FP8 value having the FP8 (or third) number format.

In embodiments implemented in a processor, the input values may be specified by one or more source operands of the machine code instruction (or instructions) which trigger the logic 100. For example, one or more source operands of the instruction(s) may point to a register or registers where the input values are currently held, and the logic circuitry 100 may be arranged to take the input values from the ore or more registers. Alternatively the input values may be pre-placed an appropriate register or registers by one or more separate put instruction, separate from the logic instruction. Or in a non RISC based architecture the input values could even be taken directly from memory.

The mode may be specified by the opcode of the instruction (i.e. there is a different instruction in the instruction set for each mode). Alternatively the mode may be specified by an operand of the instruction (i.e. there is one instruction in the instruction set for the three different modes, and the mode is set by one of the operands of the instruction). As another alternative, the mode may be determined by a control value which is set in a control register by a separate put instruction.

The logic circuitry 100 comprises multiplication logic 102 arranged to receive the pairs of input values and to multiply together each pair to produce a respective product from each pair. The logic circuitry 100 also comprises addition logic 104 which is arranged, at least in the first mode, to sum at least some of the products from the multiplication logic 102.

The multiplication logic 102 comprises first mantissa multiplying circuitry 106 which comprises at least four constituent first multiplier sub-units 114i. The multiplication logic 102 also comprises second mantissa multiplying circuitry 108, separate from the first mantissa multiplying circuitry (i.e. formed from separate electronic components). The second mantissa multiplying circuitry 108 comprises one or more second multiplier sub-units 114ii, which are different physical units than the first multiplier sub-units 114i.

The first mantissa multiplying circuitry 106 is used in the first and second modes (FP32 and FP16), but not the third mode (FP8). The second mantissa multiplying circuitry 108 is used in the third mode (FP8), but not the first and second modes. Note: it is not excluded that the first mantissa multiplying circuitry 106 could also be shared with one or more further modes having yet another number format, not further described explicitly herein.

In the first mode, as mentioned, the logic circuitry 100 receives at least one pair of FP32 values—each value having the same first number of mantissa bits (the number of mantissa bits in the first number format, e.g. 24 mantissa bits). For each value in the pair, the mantissa field is bisected into a most significant portion and a least significant portion, and each of the four multiplier sub-units 114i determines the partial product of a different combination of the most and least significant portions of the mantissas of the two input values. I.e. if the most significant portion of the first of the pair values is written as Ah and the least significant portion of that value is written Al, and similarly the most significant portion of the second of the pair is written as Bh and the least significant portion of that value is written Bl; then one multiplier sub-unit 114i performs Ah×Bh, another of the multiplier sub-units performs Ah×Bl, another multiplier sub-unit performs Al×Bh, and another performs Al×Bl. These four partial products may be calculated in parallel. The addition logic 104 sums the four partial products to determine the product of the pair of FP32 input values. This summing involves the use of bit-shifting circuitry in the addition logic 104 to shift all but one of the partial products by fixed amounts to align the partial products according to their bit significance. The size of the shifts depends on the mantissa sizes and how the mantissa is split between most and least significant portions (preferably the mantissa is split in half down the middle).

In some embodiments, the first mantissa multiplying circuitry 106 may comprise a multiple of four sub-units 114i, e.g. eight sub units 114i. This will allow it to multiply multiple (e.g. two) pairs of FP32 input values in parallel. Another way to do this would be to use just the four sub-units twice in series, but this would be slower.

Alternatively or additionally, in yet further variants it would be possible to split the FP32 mantissas into even more partial products. And a corresponding number of sub-units 114i may be provided. Four is used herein as a preferred example, but this is not limiting. For example, if the FP32 mantissas were divided into three, nine sub-units 114i would be provided.

In embodiments, the output value(s) of the logic circuitry 100 may simply be the product of the pair of input FP32 values, or the individual products of the multiple pairs of FP32 input values. Alternatively however, the addition logic 104 may be arranged to perform further addition. For example, in the case of multiple pairs of FP32 input values per operation, then as well as summing the partial products for each pair, the addition logic 104 may also sum the products of the multiple pairs. Alternative or additionally, the addition logic 104 may sum the output of the multiplication, or of the multiply-add, to a value in an accumulator register from a previous instance of the same operation, and write the result back to the same register, overwriting the previous accumulator value. This enables the logic 100 to perform a multiply-accumulate operation, accumulating the results from one instance of the operation to the next. This is useful for example to perform large vector or matrix multiplications.

In the second mode, the logic circuitry receives at least four pairs of FP16 values, each value in the four pairs having the same second number of mantissa bits (the number of mantissa bits of the second format, e.g. 12 mantissa bits). Each pair of the four pairs is multiplied by a different respective one of the same multiplier sub-units 114i that were used in the first mode, but to produce four individual products of the four pairs of lower-precision FP16 values, instead of partial products of the two higher-precision FP32 values.

Preferably the FP32 (or first) number format has twice the number of mantissa bits as the FP16 (or second) number format, so that the bit-width of each multiplier sub-unit 114i is fully exploited in both modes. However, this is not essential, and the multiplier sub-units 114i used for the first format could be shared with a second format that does not have exactly half the mantissa bits, by padding the shorter mantissa with zeros when passing through the multiplier sub-unit 114i.

In embodiments, these individual products could simply form the output values of the logic circuitry 100 as a whole, and the addition logic 104 is not necessarily used in the second mode. However, in other embodiments, the addition logic 104 is arranged so as, in the second mode, to add together the four individual products. Optionally, depending on implementation, the addition logic 106 may also add one or more other values. E.g. in embodiments where the multiplication logic 102 comprises multiple (e.g. two) groups of four multiplier sub-units 114i and the logic 100 receives a corresponding number of FP16 input values in the second mode, then the addition logic 104 may add together the products of all the pairs of FP16 input values (e.g. all eight pairs). Alternatively or additionally, the addition logic 104 may add the sum of the products to value in an accumulator register and overwrite the previous result, similarly to the way described previously with respect to the first mode. Again this provides an efficient way to perform vector or matrix multiplications, for example.

If the addition logic 104 is used, in whatever way, then the sum produced by the addition logic 104 forms the overall output of the logic circuitry in the second mode.

In the third mode, the logic circuitry 100 receives a plurality of pairs of FP8 input values, each value in the plurality of pairs having the same third number of mantissa bits. E.g. these may each have a 2, 3 or 4 bit mantissa field, depending on the exact format used in the implementation in question. In the third mode, the multiplication logic 10 multiplies each pair of FP8 values using the dedicated second mantissa multiplying circuitry 108, instead of the first mantissa multiplying carry 106. In embodiments, the second mantissa multiplying circuitry comprises one second multiplier sub-unit 114ii per pair of input FP8 values, each sub-unit determining a different respective one of the corresponding products. This enables all the products to be determined in parallel. However it is not excluded that in alternative implementations, there could be fewer multiplier sub-units 114ii in the second mantissa multiplying circuitry, and which case some or all of the multiplications would have to be performed in series with one another. This would be slower than doing them in parallel, but still possible.

Either way, it is recognized herein that it is preferable to provide separate dedicated mantissa multiplying circuitry 108 for the third (e.g. FP8) mode, rather than try to re-use the first mantissa multiplying circuitry 106 that is shared between the first and second (e.g. FP32 and FP16) modes. For larger number formats such as FP32 and FP16, the mantissas are large and so the complexity of the silicon for performing a given product (or partial product) is fairly high, so it would not be desirable to duplicate this circuitry. Also typically only a relatively small number of products are going to be determined per operation (e.g. per machine code instruction). On the other hand, for small number formats like FP8, the mantissas are fairly small (perhaps only 4, 3 or even 2 bits per value), so the multiplying circuitry per product is small and can be duplicated without so much penalty. Whereas the amount of extra multiplexity circuitry that would be required to share the mantissa multiplying circuitry 106 with the larger-format first and second formats would outweigh any saving in silicon footprint that would be gained by not duplicating. Particularly, to share the mantissa multiplying circuitry 108 with an even smaller number format mode than the second mode, such as FP8, this would require the pair of input values in the first mode to be split into a much larger number of partial products. For example, if the mantissas in the FP8 mode were each 4 bits, the FP16 mantissas were each 12 bits and the mantissas in the FP32 mode were each 24 bits, then providing a design able to reuse the same multiplication circuitry in all three modes would involve eighteen 4-bit multipliers, with multiplexing circuitry able to select to combine them in different ways so as to perform i) nine partial products of 8-bit mantissa portions (dividing the mantissa into thirds) in the FP32 mode, and ii) up to six products of six respective pairs 12-bit mantissas in the FP16 mode, and iii) up to nine products of nine respective pairs of 8-bit mantissas in the FP8 mode. The multiplexing circuitry required to do this would itself increase both the silicon footprint and the power required.

In embodiments, the plurality of individual products calculated in the third mode could simply form the output values of the logic circuitry 100 as a whole in the third mode, and the addition logic 104 is not necessarily used. However, in other embodiments, the addition logic 104 is arranged so as, in the third mode, to add together the plurality of individual products. Alternatively or additionally, the addition logic 104 may add the sum of the products to value in an accumulator register and overwrite the previous result, similarly to the way described previously with respect to the first and second modes.

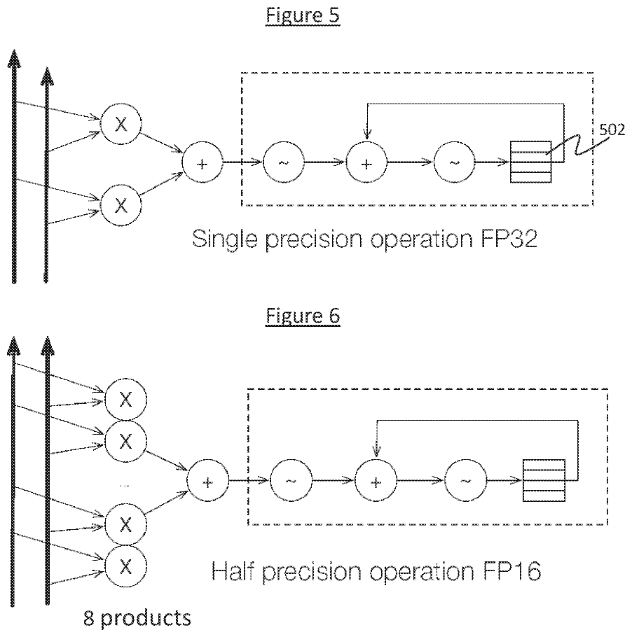

FIGS. 5-7 show a set of compound operations that may be performed in one example implementation of the logic circuitry of FIG. 1. In these figures, the symbol (X) represents a multiplication operation, the symbol (+) represents an addition operation, and the symbol (˜) represents an optional normalization stage.

In FIG. 5, the logic circuitry 100 (operating in the first mode) takes two pairs of FP32 input values, and the first mantissa multiplying circuitry 106 multiplies each pair (e.g. using two parallel groups of four multiplier sub-units 114i), sums the two products, and then adds the sum of the products to an accumulator value in an accumulator register 502. This sum is then written back to accumulator register 502, overwriting the previous value. Thus the logic circuitry 100 implements a multiply-accumulate operation, which accumulates a rolling sum from one operation to the next (e.g. one machine code instruction to the next). Note: the accumulator register 502 is shown in the figures as part of a register file, but in embodiments only one field of this is needed. Note also: the vertical lines on the left hand side represent buses, each of which may carry multiple input values (e.g. two FP32 values) in parallel, and deliver a different one to the input of each multiply operation (X).

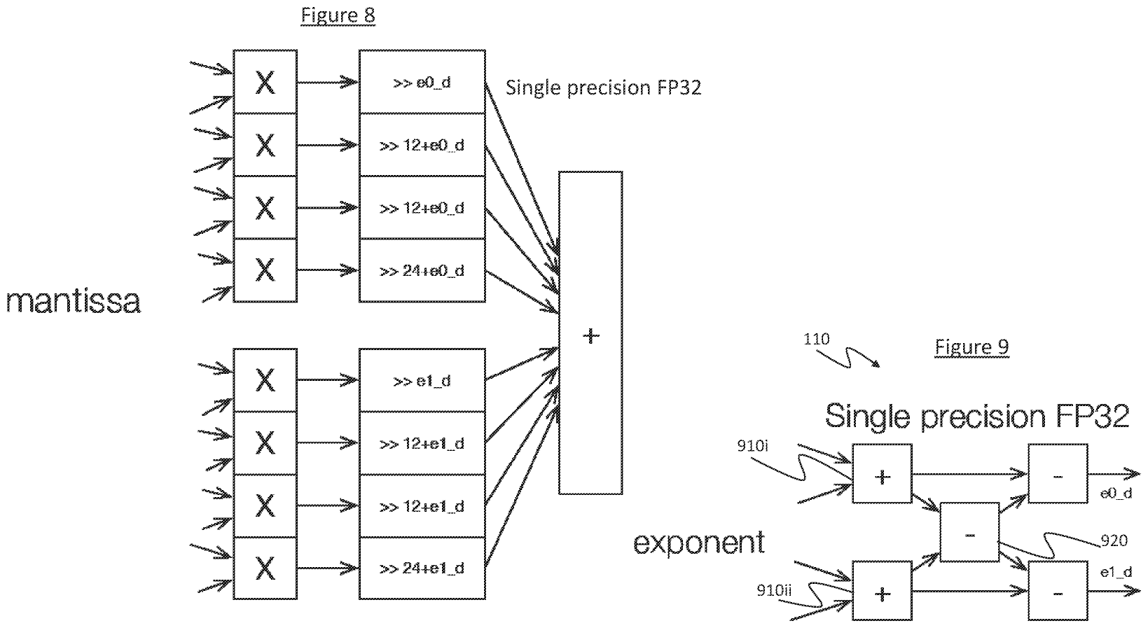

FIG. 8 schematically illustrates the constituent multiplication and add operations, i.e. the (X)s and first (+) in FIG. 5, before the accumulate. The top four lines represent the four partial products (AhBh, AhBl, AlBh, AlBl) of the first pair of FP32 values, and the bottom four lines represent the four partial products of the second pair of FP32 values. Note the shifting by fixed amounts depending on the bit-significance of the partial products, where in this example the mantissa of the FP32 format is 24 bits, so each half of the mantissa is 12 bits, with there being a most significant 12 bits and a least significant 12 bits per 24-bit mantissa. Thus the most significant partial product Ah×Bh is not shifted, the two middle-most significant partial products Ah×Bl and Al×Bh are shifted right by half the mantissa size (in this example 12 bits), and the least significant partial product Al×Bl is shifted right by the full 24 bits of the mantissa length.

FIG. 6 shows an example of the second mode. Here the logic circuitry 100 takes eight pairs of FP16 input values. The two groups of four sub-units 114i in the first mantissa multiplying circuitry 106 (which were used for the two sets of partial products in the first mode) are now used to determine the products of the eight pairs of FP16 input values. The addition logic 104 sums all eight products, and then adds this sum to the value in the accumulator register 502, and writes the value back to the accumulator register.

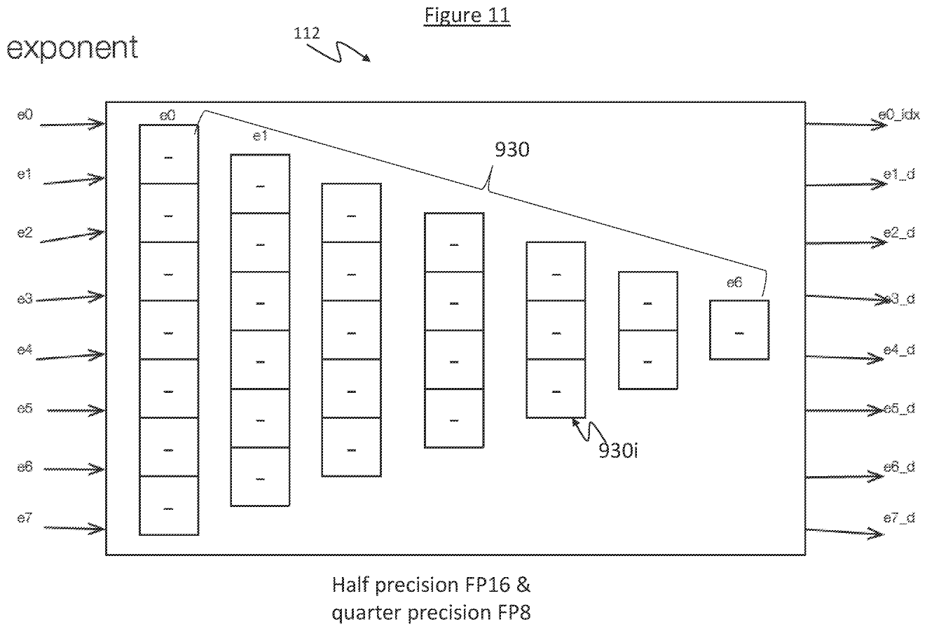

FIG. 10 schematically illustrates the constituent multiplication and add operations of the second mode, i.e. the (X)s and first (+) in FIG. 6 before the accumulate. Each line represents the multiplication of a different pair of FP16 values. Note how the shifting by the shifting circuitry in the addition logic 104 now involves a variable shift per line (in all but one of the lines), since it is now adding eight arbitrary product values which could have any arbitrary exponent size (unlike the case where adding partial products which have a predetermined alignment relative to one another).

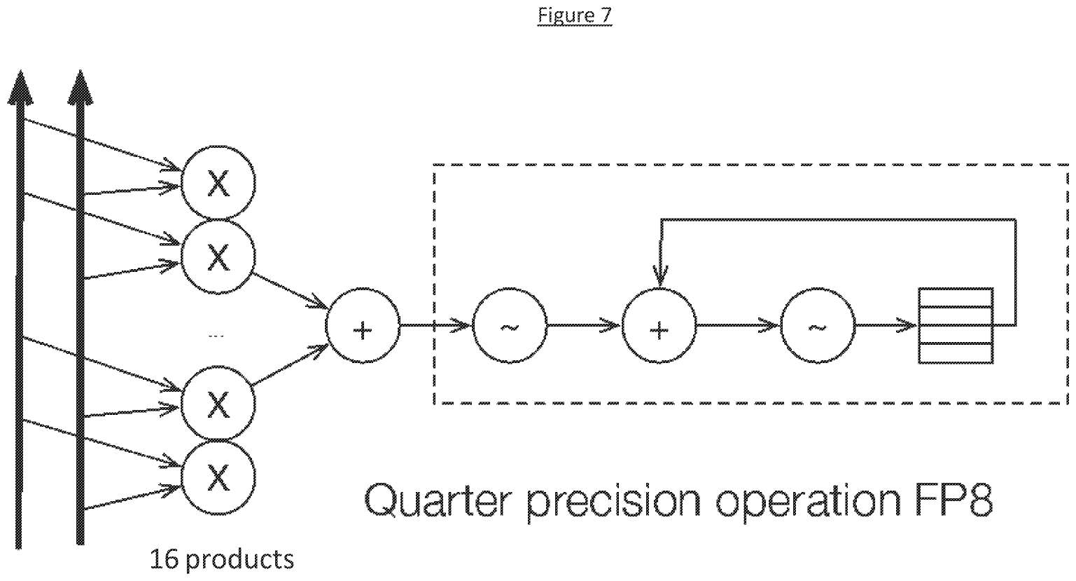

FIG. 7 illustrates an example of the third mode. Here the logic circuitry 100 takes sixteen pairs of FP8 input values. In this mode, the second mantissa multiplying circuitry 108 (rather than the first mantissa multiplying circuitry 106) is used to determine the products of the sixteen pairs of FP8 input values. This may be done with sixteen parallel second multiplier sub-units 114ii. The addition logic 104 sums all eight products, and then adds this sum to the value in the accumulator register 502, and writes the value back to the accumulator register.

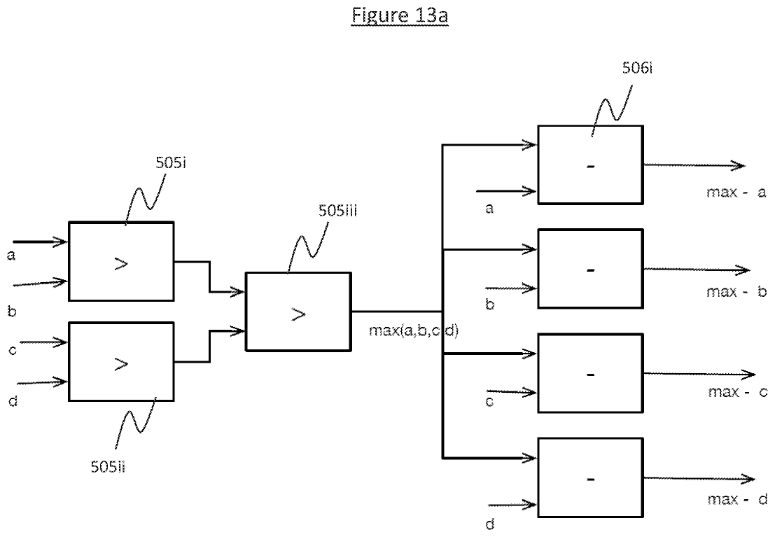

FIG. 12 schematically illustrates the constituent multiplication and add operations of the second mode, i.e. the (X)s and first (+) in FIG. 7 before the accumulate. Again the shifting by the shifting circuitry in the addition logic 104 now involves a variable shift per line (in all but one of the lines).

Turning to the addition logic 104 in more detail, as the skilled person will be aware, adding floating point values involves shifting the mantissas of at least all but one of the mantissas (typically all but the largest) of the values being added (the addends), according to their exponents. This involves comparing the exponents, which if there are more than two addends means sorting the exponents. Typically this means comparing (e.g. sorting) determine which is the largest, and then determining the “distance” of each other exponent to the largest (i.e. the difference or “delta” between the exponent in question and the largest component).

Sorting in this context means comparing a number of values to determine a largest value. It could equally describe any systematic comparison between more than two values (it does not necessarily imply producing a sorted list or suchlike).

If adding only a small number of values in the larger number format first mode such as the FP32 mode, then this exponent comparing can be done using only relatively simple circuitry. In the case of adding only two values, such as the outputs of two FP32 multiplications, then the exponent comparing circuitry can take a very simple design for comparing only two exponent values. However, when there are a larger number of values to be added, resulting from the products of a larger number of pairs of smaller number format values, as in the second and third mode, then more complex exponent sorting circuitry will be needed.

Therefore in embodiments, the addition logic 104 comprises first exponent comparing circuitry 110 for comparing the exponents for the purpose of addition in the FP32 (or first) mode, and second, separate exponent comparing circuitry 112 in the form of exponent sorting circuitry for sorting more than two exponents for the purpose of addition in the FP16 and FP8 (or second and third) modes. In embodiments the first mode may add a pair of products and the first exponent comparing circuitry 110 may be configured to compare only a single pair of FP32 numbers. This enables the more complex and power hungry sorting circuit 112 to be switched off during the first mode.

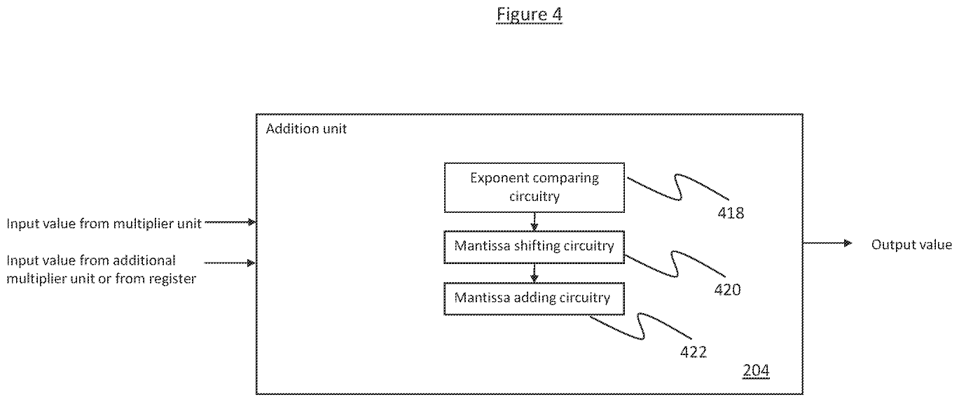

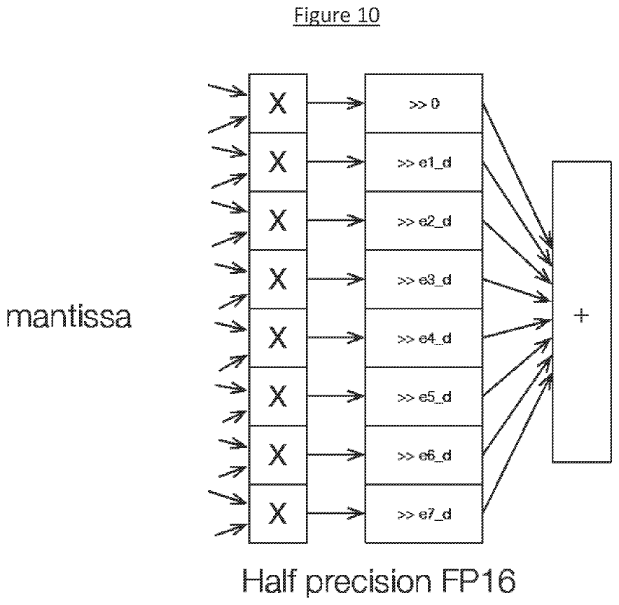

FIG. 9 shows an example of the simple exponent comparing circuitry 110 which may be used to compare a pair of values in the first mode. Each addition unit 910 takes two exponent values for each of a pair of values being multiplied in the first mode, and outputs the exponent value for the product. This value is then input into subtraction unit 920i. This unit subtracts one product exponent value from a second product exponent value, for example the output of 910ii from the output of 910i. The result of this subtraction may be positive or negative. If the result is positive, then the output of 910i is greater, and so the shift should be relative to this value. If the result is negative, then the output of 910ii is greater, and so this shift should be relative to this value. Subtraction unit 920i outputs a single bit indicating whether the subtraction is positive or negative, and sends this to both of subtraction units 920ii and 920iii. Subtraction unit 920ii is multiplexed such that if the sign of 920i is positive, it subtracts the output of 910i from the output of 910i, i.e. subtracts the maximum output from itself, giving a result of zero. If the sign of 920i is negative, then it subtracts the output of 910i from the output of 910ii, which gives a positive shift value as an output. Subtraction unit 920iii is correspondingly multiplexed, such that the output is either zero or a positive shift value. These shift values are then output to mantissa shifting circuitry, such as mantissa shifting circuitry 420 of FIG. 4.

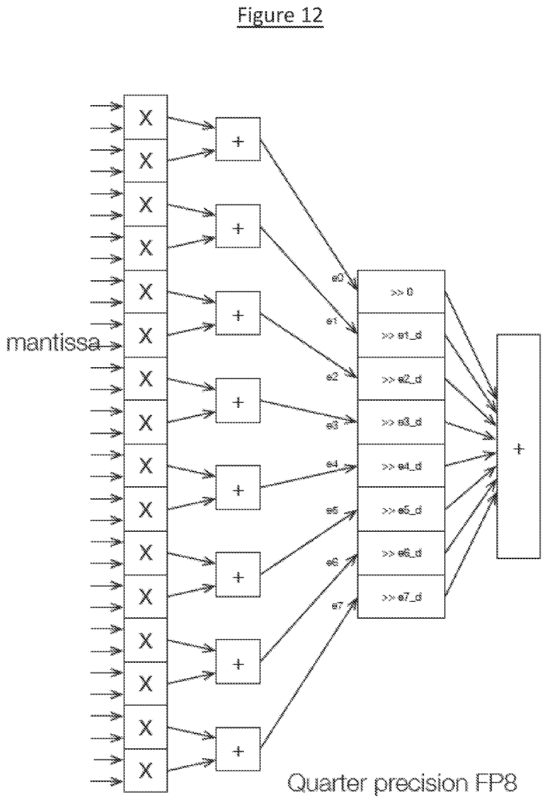

FIG. 11 shows an example of the exponent sorting circuitry 112 which may be used to sort the exponents of multiple values in the second and third modes. The circuitry takes as input the exponent values e0, e1 . . . e7, each representing the exponent portion of a floating point value. The subtraction units 930 (such as 930i) each represent a unit capable of taking two inputs. In the first column marked e0, each unit takes as one input e0. Each subtraction unit takes as its second input value a different respective exponent value of the set e1−e7. This means that the first column of subtraction units computes the difference between e0 and each other exponent value. Note: this description has employed the convention of calculating e0−ei, but since e0−e1 is the complement of e1−e0, other embodiments could have e0 as the second input to the subtraction.

The second column, marked e1, computes the differences between the remaining exponents and e1. It is not necessary to recalculate the differences relative to e0, since this has already been calculated in the first column. The second column therefore comprises six subtraction units, each taking as one input e1 and as a second input one of the remaining exponents.

The same process is carried out in the subsequent columns, resulting in calculation of the differences between each possible pairing of exponents. Some of these differences will be positive, and some will be negative. If the differences e0−ei include some negative values, then e0 is not the largest exponent and it is necessary to check the next column of values. If the differences e1−ei include some negative values, then e1 is also not the largest exponent. When a column en is reached with no negative values, then exponent en is the largest exponent. Note that if the inputs were reversed such that e0 was the second input to the subtraction, this process would be reversed such that en would be the first exponent with no positive values of differences.

Once the maximum exponent has been found, the distances between each exponent and the maximum exponent en are output from the comparing circuitry to the shifting circuitry. The distance of at least en with itself is zero. There may be two equal highest exponent values, in which case two of the distances will be zero. Conventionally the distances are output as positive shift values, which may be the complement of the subtractions, determined by the modulus function |en−ei|.

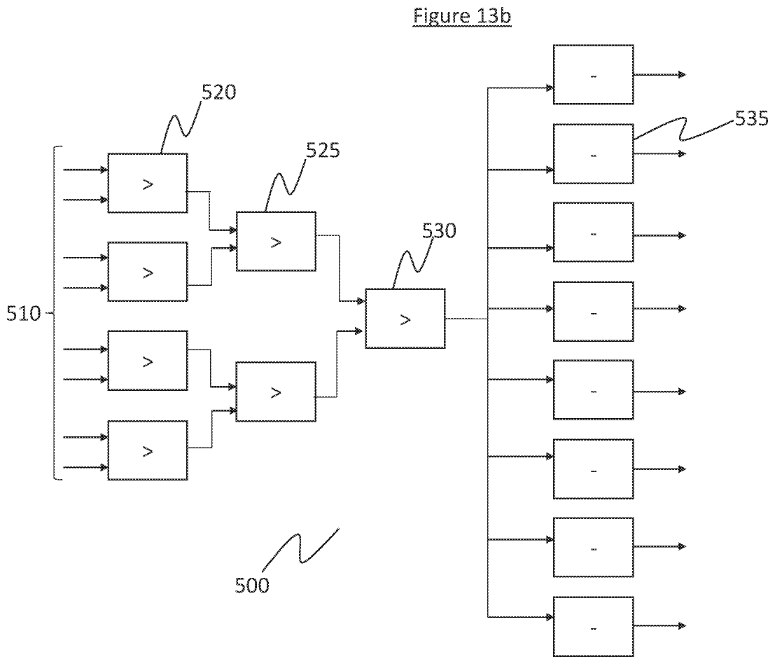

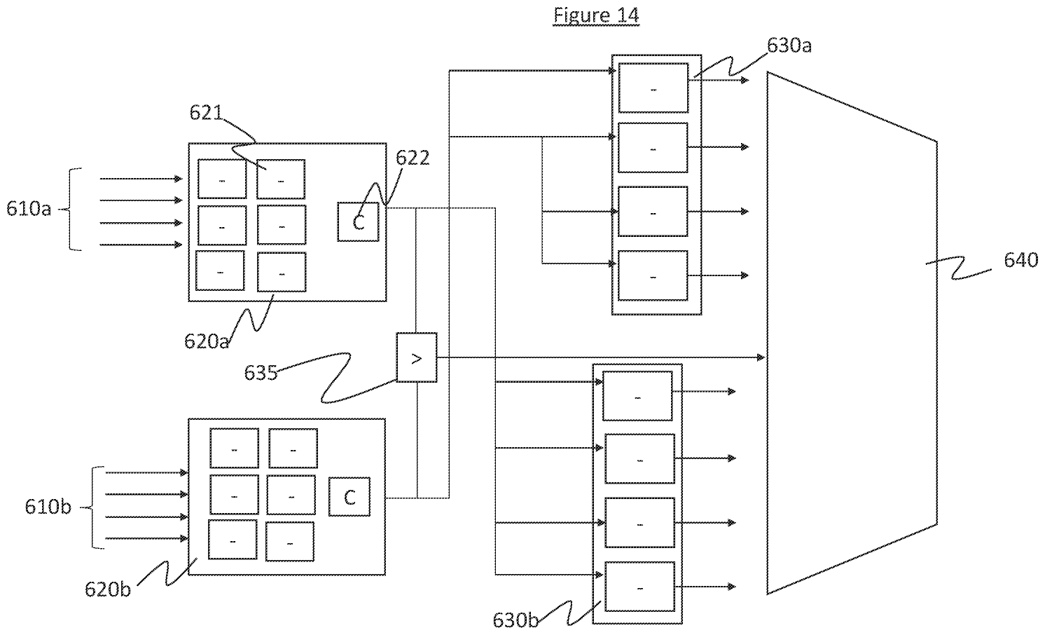

An alternative method of exponent comparing is shown in FIG. 13a. FIG. 13a shows four input exponents a-d input into comparison units 505i, 505ii. These comparison units determine the greater of the inputs. For example, this may be by subtracting the first input from the second input, and then observing the sign of the output. The greater of the input values from each of comparison units 505i and 505ii is then input into the second stage comparison unit 505iii. The output of the final comparison unit is the largest exponent value. It is then necessary to calculate the distances between each exponent value and the largest exponent value. This is done by the subtraction units 506i. The output distances are then sent to the mantissa shifting circuitry. Note that one of the values a-d will be the maximum value, meaning that at least one of the subtraction units will have an output of zero.

A further alternative method of exponent comparing is shown in FIG. 13b. FIG. 13b shows an exponent comparing unit 500 comprising comparator units 520, 525, 530, and subtractor units 535. Each of the comparator units 520 are operatively coupled to one of the comparator units 525, and each of the comparator units 525 are operatively coupled to the comparator unit 530. The comparator unit 530 is operatively coupled to each of the subtractor units 535.

In operation, eight exponents 510 are input into comparison units 520 525, 530. These comparison units 520 each determine the greater of two inputs. For example, this may be by subtracting the first input from the second input, and then observing the sign of the output. The greater of the input values from each of comparison units 520 is then input into the second stage comparison unit 525. The greater of the input values from each of the comparison units 525 is then input into the third stage comparison unit 530. The output of the final comparison unit 530 is the largest exponent value of the input values 510. It is then necessary to calculate the differences between each exponent value and the largest exponent value. This is done by the subtraction units 535. The differences output by each of the subtractor units 535 are then sent to the mantissa shifting circuitry. Note that one of the values 510 will be the maximum value, meaning that at least one of the subtraction units will have an output of zero.

Note however it is not essential to provide separate dedicated exponent comparing circuitry 110 for the first mode. Alternatively the same exponent sorting circuitry 112 could be used for all three modes.

FIG. 14 illustrates further alternative circuitry for comparing exponent values.

FIG. 14 shows a circuit comprising first comparing circuitry 620a, second comparing circuitry 620b, third comparing circuitry 635, first difference calculating circuitry 630a, second difference calculating circuitry 630b, and multiplexer 640. The first comparing circuitry 620a and second comparing circuitry 620b are operatively coupled to the third comparing circuitry 635. The first comparing circuitry 620a is also operatively coupled to the first difference calculating circuitry 630a. The second comparing circuitry 620b is also operatively coupled to the second difference calculating circuitry 630b. The first comparing circuitry 620a, second comparing circuitry 620b, third comparing circuitry 635, first difference calculating circuitry 630a, and second difference calculating circuitry 630b are all operatively coupled to the multiplexer 640.

The first comparing circuitry 620a and the second comparing circuitry 620b each comprise subtractor units 621. In one embodiment, the first comparing circuitry 620a and the second comparing circuitry 620b each comprise six subtractor units 621. The first comparing circuitry 620a and the second comparing circuitry 620b also each comprise at least one control unit 622. In one embodiment, the first comparing circuitry 620a and the second comparing circuitry 620b each comprise a single control unit 622.

In operation, the first comparing circuitry 620a and the second comparing circuitry 620b each take as input a respective group of values. The first comparing circuitry 620a takes as input the group of values 610a, while the second comparing circuitry 620b takes as input the group of values 610b. In one embodiment, each group of values 610a, 610b consists of four values. The first comparing circuitry 620a determines the largest value of the group of values 610a. In one embodiment, this is determined by calculating the difference between every unique pair of values that can be formed from the group of values taken as input. For example, if the values in group 610a were labelled A, B, C, and D, the first comparing circuitry 620a would calculate A-B, A-C, A-D, B-C, B-D, C-D. The order of the values within these pairs is arbitrary—equally the first comparing circuitry 620a could calculate B-A and gain the same information about the relationship between the two numbers, namely which of the input numbers is larger. In an alternative embodiment, the largest value of the group of values 610a may be determined by calculating the difference between fewer pairs of values than the number of unique pairs. For example, if four values labelled A, B, C, and D were taken as input, the first comparing circuitry 620a could calculate A-B and C-D. If A and

C were larger than B and D respectively, the first comparing circuitry 620a would then calculate A-C. This requires fewer subtractor units 621, but two additional control units 622, and does not allow all operations to be done in parallel, as it requires two rounds of calculation, in which the second round depends on outcome of the first round.

Although these embodiments have been described in terms of four input values, this is not intended to be limiting. For example, if six values were input into the first comparing circuitry, an embodiment calculating all unique pair differences would carry out 21 calculations. An alternative embodiment calculating the pair differences in three stages could carry out five difference calculations. Further embodiments could carry out intermediate numbers of difference calculations. For example, an embodiment calculating the pair differences in two stages could carry out six difference calculations.

A control unit 622 in the first comparing circuitry outputs the largest value of the input values 610a to the third comparing circuitry 635. The differences between this largest value of the first group 610a and the other values of the first group 610a are output to the multiplexer 640. In the embodiment in which all unique pair differences are calculated, this requires no further processing. In the embodiment in which fewer pairs of values are calculated than unique pairs of values exist, this requires calculating of additional pair differences. For example, if A-B, C-D, and A-C are calculated, showing that A is the largest, then the missing difference is the difference between A and D. In this embodiment, at least one additional subtractor 621 may be implemented after the control unit 622. This at least one subtractor 621 may be within the first comparing circuitry 620a, or alternatively may be operatively coupled to the first comparing circuitry 620a.

The second comparing circuitry 620b takes as input a respective group of values 610b. This group of values 610b is non-overlapping with the group of values 610a taken by the first comparing circuitry 620a. For example, if the first comparing circuitry 620a takes as inputs values A, B, C, D, the second comparing circuitry 620b may take as input values E, F, G, H. In one embodiment, the second comparing circuitry 620b takes the same number of inputs as the first comparing circuitry 620a. In an alternative embodiment, the second comparing circuitry 620b may take a different number of inputs to the first comparing circuitry 620a, either due to an alternative hardware configuration, or due to a supply of fewer values than the circuitry is configured to take. For example, the second comparing circuitry 620b may be configured to take four input values, but may be supplied with only three values at a certain point in calculation. In this scenario, some subtractor units 621 would not be used.

Like the first comparing circuitry 620a, the second comparing circuitry 620b computes differences between pairs of values to output the largest value of the group of input values 610b to the third comparing circuitry 635, and outputs the difference between this largest value and the other values of the group 610b to the multiplexer 640.

The third comparing circuitry 635 comprises at least one subtractor unit 621. The at least one subtractor unit 621 takes as input the largest values from the first and second group comparing circuitry 620a, 620b. In one embodiment, the third comparing circuitry 635 outputs an indication of whether or not the largest value from the first group 610a is the largest overall value. In another embodiment, the third comparing circuitry 635 further outputs the difference between the two values to the multiplexer 640.

The first difference calculating circuitry 630a comprises a number of subtractor units 621. In one embodiment, this is equal to the number of input values in the group 610a. For example, there may be four subtractor units 621 in the first difference calculating circuitry 630a in the embodiment in which the first group of values 610a consists of four values. Alternatively, the number of subtractor units 621 may be configured to be lower than the number of input values. For example, the first group of values 610a may consist of eight values, and the number of subtractor units 621 in the first difference calculating circuitry 630a may be four. In this embodiment, the subtractors 621 would have to be used in serial for some of the calculations, rather than conducting all of the calculations in parallel.

In operation, the first difference calculating circuitry 630a takes as input the values 610a from the first group comparing circuitry 620a, and the largest value output from the second comparing circuitry 620b. The first different calculating circuitry 630a calculates the difference between each value of the first group 610a and the largest value of the second group 610b. For example, if the largest value of the second group 610b is labelled E, and the values of the first group 610a are labelled A-D, the first difference calculating circuitry 630a would calculate E-A, E-B, E-C, and E-D. This could be done by each of four subtractor units 621 calculating one sum. Alternatively, two subtractor units 621 could calculate two sums sequentially. The differences calculated by the subtractor units 621 are then output to the multiplexer 640.

The second difference calculating circuitry 630b also comprises a plurality of subtractor units 621. In one embodiment, the number of subtractor units 621 in the second difference calculating circuitry 630b is the same as the number of values in the second group 610b. Alternatively or additionally, the number of subtractor units 621 in the second difference calculating circuitry 630b may be the same as the number of subtractor units 621 in the first difference calculating circuitry 630a.

In operation, the second difference calculating circuitry 630b takes as input the second group of values 610b, and the largest value of the first group 610a. The second difference calculating circuitry 630b calculates the difference between the largest value of the first group 610a and each of the values from the second group 610b, and outputs these differences to the multiplexer 640.

The multiplexer 640 comprises multiplexing logic. In operation, it takes as input the differences from the first comparing circuitry 620a, second comparing circuitry 620b, third comparing circuitry 635, first difference calculating circuitry 630a, and second difference calculating circuitry 630b. If the third comparing circuitry 630b indicates that a value from the first group 610a is the largest overall value, i.e. that of the values labelled A-F, value A is the largest, then the differences from the first comparing circuitry 620a and the second difference calculating circuitry 630b are output from the multiplexer 640. In other words, the differences between value A and the values B-D from the first comparing circuitry 620a are output, while the differences between the values in the group E-H are discarded, and the differences between value A and the values E-H from the second difference calculating circuitry 630b are output, while the differences between the largest value from the second group (here labelled E) and the values B-D are discarded. The difference between A and E may be output from the third comparing circuitry 635, the first difference calculating circuitry 630a, or the second difference calculating circuitry 630b. In one embodiment, the difference is output from the second difference calculating circuitry 630b. Alternatively, if the third comparing circuitry 635 indicates that the largest overall value is a value from the second group 610b, i.e. the largest overall value is the largest value of the second group, then the multiplexer 640 outputs the differences calculated by the second group comparing circuitry 620b and the first difference calculating circuitry 630a, discarding the remaining differences.

Advantageously, the third comparing circuitry 635, the first difference calculating circuitry 630a and the second difference calculating circuitry 630b may all run in parallel. The first group comparing circuitry 620a may also run in parallel to the second group comparing circuitry 620b. This means that the entire process may complete in fewer clock cycles than would be required for comparable calculations done using the value comparing circuitry of FIG. 13. FIG. 13 does employ fewer subtraction units, but employs more control units and multiplexing logic.

The value comparing circuitry of FIG. 14 is a novel balance between the twin requirements of speed, power preservation, and reduced silicon footprint. Advantageously, the value comparing circuitry of FIG. 14 provides a greater improvement in terms of power and speed than merely a linear extrapolation of the power requirements between FIGS. 11 and 13b, as the multiplexing logic required in FIG. 14 is simpler than that required for the circuitry of FIGS. 11 and 13b.

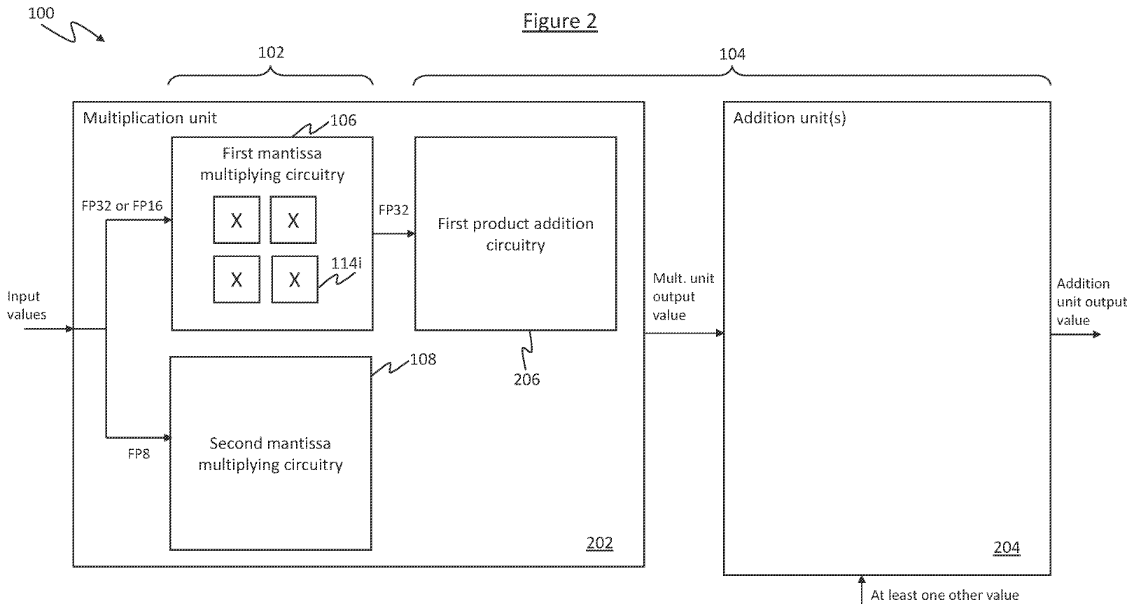

FIG. 2 illustrates one possible division of the logic circuitry 100 of FIG. 1 into constituent units: a multiplication unit 202 and an addition unit 204. The multiplication unit 202 comprises the multiplication logic 102 of FIG. 1, and further comprises at least first product addition logic 206. The addition logic 104 of FIG. 1 is divided between the first product addition circuitry 206 of FIG. 2, which may be considered part of the multiplication unit 202; and the separate addition unit 204. The first product addition circuitry 206 is included in order to sum the four partial products of a pair of FP32 input values. Hence it may be thought of as part of the multiplication unit 202. This product addition circuitry 206 may be re-used in the second mode in order to sum the four products from the four pairs of FP16 input values. It may also be re-used in the third mode to perform at least part of the summing of the products of the FP8 values.

In embodiments, the logic 100 may comprise multiple instances of the multiplication unit 202, e.g. one for each pair of FP32 values in the example of FIG. 5. The addition unit 204 may be arranged to add the outputs of the multiple multiplication units 202, e.g. the first (+) in FIGS. 5 to 7. Alternatively or additionally, the addition unit 204 may be arranged to perform the accumulation with the value in the accumulator register 502, e.g. the second (+) in FIGS. 5-7.

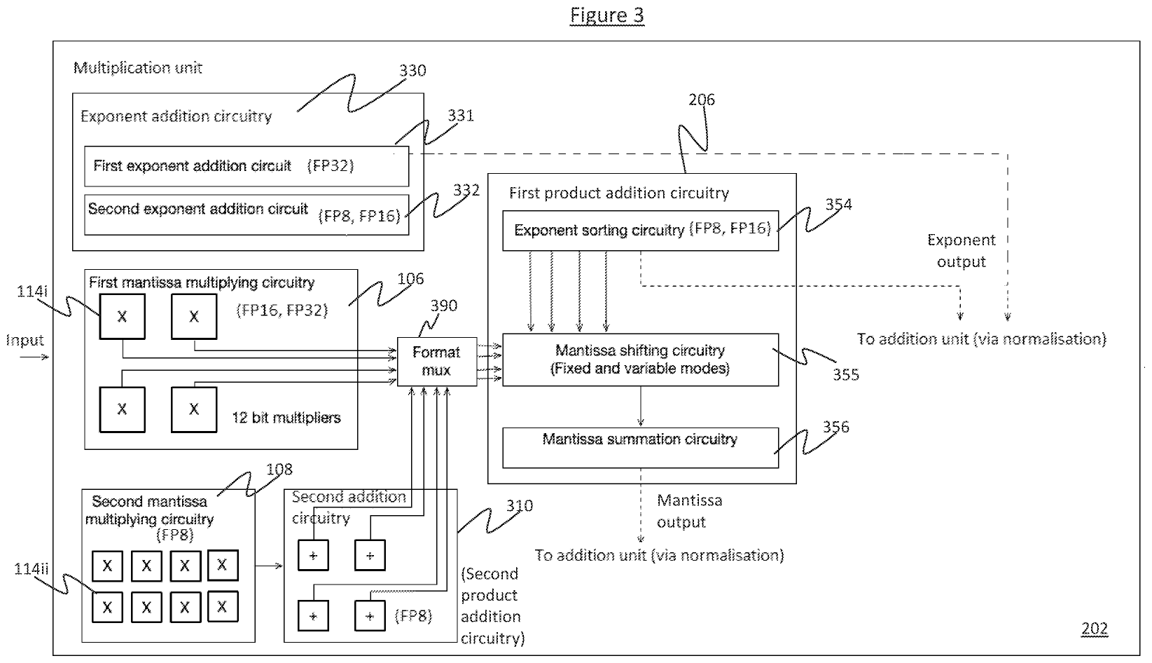

FIG. 3 illustrates an example implementation of the multiplication unit 202. Here, the multiplication unit 202 comprises: the first mantissa multiplying circuitry 106, the second mantissa multiplying circuitry 108, the first product addition circuitry 206, second product addition circuitry 310, exponent addition circuitry 330, and a format multiplexer 390. The exponent addition circuitry 330 comprises a first exponent addition circuit 331 and a second exponent addition circuit 332. The first product addition circuitry 206 comprises exponent sorting circuitry 354, mantissa shifting circuitry 355, and mantissa adding circuitry 356.

In the first mode, the multiplication unit 202 takes as input two input values of a first, higher precision number format. For example, the number format of the input values may be 32-bit floating points (also known as FP32). The number format may specify a number of mantissa bits of the first number format. For example, the first number format may specify that the mantissa has 24 bits. In the first mode, the mantissa is split into at least two portions, at least a most significant portion and a least significant portion. These may be two equal portions—in other words, the mantissa may be bisected. For example, each mantissa could be split into two 12 bit portions. The partial product of the two input values is computed by first using the most and least significant portions to calculate partial products. Each multiplier sub-unit 115 computes a partial product.

Partial products is a term used in mathematics for finding a final product by summing several intermediate products. For example, the product 12×34 is equivalent to the sum of the partial products 10×30, 10×4, 2×30, 2×4. These partial products could be rewritten as 1×3×100, 1×4×10, 2×3×10, 2×4. This separates out the positional value from the digits themselves. As this example was in the decimal system, the first of the two digits had the place value 10. For the partial products, each digit multiplication must be adjusted to reflect the place value. In the above series of partial product, the adjustment is shown as the power of ten following the digit multiplication.

This technique is commonly used in mental arithmetic in the decimal system. However, the principle may be applied in other bases, such as binary, and need not compute the partial product for each digit individually. For example, the product 123×456 could be done by calculating the partial products 12×45, 12×6, 3×45, 3×6, and then multiplying each of these values by their digit position before finally summing them together.

These partial products are then bit shifted to the appropriate positions by the mantissa shifting circuitry 355, and then are combined by the mantissa summation circuitry 356. For example, if a pair of 24 bit mantissas are bisected into most significant and least significant portions, and the partial products are then computed, then the partial product of two most significant portions must be shifted by 24 bits relative to the least significant portions. This may be done by shifting the bits of the most significant product in the direction of greater significance, or by shifting the bits of the least significant product in the direction of least significance. The products of the most significant portion of one mantissa with the least significant portion of the other mantissa similarly require a shift of 12 bits relative to the most significant product in the direction of lower significance, or in the direction of higher significance if the shifts are relative to the least significant product.

In one embodiment, the shifts are done in the direction of lower significance, such that the partial product of the two most significant portions is not shifted.

Although in the above embodiment of the first mode the mantissas have been split into equal portions, in other embodiments the mantissas could be split into unequal portions. Although in the above embodiment the mantissas have been split into two portions, in other embodiments the mantissas could be split into different numbers of portions. For example, each mantissa could be split into three portions.

The shifted partial products are then added together by mantissa summation circuitry 356. This gives a final mantissa output for the product of the pair of higher-precision values of the first mode.

In one embodiment, the product exponent value in the first mode is found using exponent addition circuitry 330. Alternatively, the exponent addition could in principle be done using software. Where done in hardware, the exponent addition circuitry 330 may comprise a first exponent addition circuit 331 and a second exponent addition circuit 332. In one such embodiment, the first exponent addition circuit 331 is used to find the product exponent value in the first mode but not in other modes. In an alternative embodiment, there is only one set of exponent addition circuitry common to all modes.

The product exponent value and the product mantissa value are output from the logic circuitry 100 together as an output value of the logic circuitry 100. This output value may then be placed into a destination register, and/or input into further logic circuitry.

In the second mode, the multiplication unit 202 is used to process four pairs of floating point values of a second, intermediate precision number format. For example, the numbers may be expressed in 16 bits. Alternatively or additionally, the mantissa may take up 12 bits. The mantissas of these numbers are multiplied using the multiplier sub-units 114i, each sub-unit multiplying a pair of mantissas. This means that all four pairs may be processed in parallel.

The four individual product values may be output from the multiplication unit 202 as multiple output values. However in some embodiments, the resultant products are instead summed using the product addition circuitry 206 (part of the addition logic 104 of FIG. 1). I.e. this can be performed by re-using the same four multiplier sub-units 114i as used to determine the four partial products in the first, FP32 mode.

Adding two floating points requires adjustment of the mantissas such that the exponents are equal. If it is not known that the exponents are already equal, as in the case of summing two arbitrary values, then before adding the products, all but one of the mantissas must be shifted by the mantissa shifting circuitry 355. This requires finding the exponents of each product, comparing said exponents, and then shifting each mantissa by the appropriate amount. This is done using the exponent sorting circuitry 354. In embodiments the exponent sorting circuitry may take the same design as that described in relation to FIG. 11, but with four layers (four sorting stages, i.e. four columns as shown from left to right in FIG. 11) instead of eight, as in this example there are only four input exponents to be sorted. In another example implementation, the design of FIG. 13 could be used.

In some embodiments, the exponents of the products may be found using exponent addition circuitry 330. In one embodiment, the exponents are found using second exponent addition circuit 332. In other embodiments, the exponents are found using software alone, or are already known to the program. In further embodiments, the exponents and the necessary mantissa shifts are calculated using software.

In one embodiment, the mantissa shifts are determined relative to a largest exponent. In other embodiments, the mantissa shifts may be determined relative to the smallest exponent, or by another criterion, such as relative to the first exponent value to be calculated or otherwise provided to the circuit.

The product mantissas corresponding to each of the four pairs of input values are then shifted by the appropriate shifts using mantissa shifting circuitry 355. The shifted mantissas are then summed to generate a sum of the products. The mantissa value of the sum and the exponent value of the sum are then output from the multiplier unit 202 as the output value. In some embodiments, this value is then normalised using normalisation circuitry.

In the third mode, the logic circuitry of FIG. 3 is used to process eight pairs of floating point values of a third, lower precision number format. For example, the numbers may be expressed in an 8-bit format. In one embodiment, the mantissas have three bits. In another embodiment, the mantissas have four bits. In another embodiment, the mantissas have two bits.

Each pair multiplication is done using the second mantissa multiplying unit 308. In one embodiment, the second mantissa multiplier unit may have eight multiplier sub-units 114ii. These multiplier sub-units may be configured differently to the multiplier sub-units 114i. For example, these multiplier sub-units may be configured to take fewer bits as input to the multiplication.

In some embodiments, the exponents of each pair of values are added to give the exponent for each product using the exponent adding circuitry 330. In one embodiment, the exponents are added using second exponent adding circuit 332. Alternatively, the product exponent values could in principle be found using software.

In the third mode, the plurality of individual products of the plurality of pairs of FP8 input values could simply be output from the multiplication unit 202 as a plurality of individual output values. However, in embodiments, instead the products of the individual FP8 multiplications of the third mode are summed together to give a single summed value as the output of the multiplication unit 202. This may be done partly using the second product addition circuitry 310 to add together some of these products into intermediate sum values, then passing the intermediate sum values to the first product addition unit 206 to perform the rest of the summing. In this case the format multiplexer 390 switches the input of the first product multiplying circuitry 206 between the first mantissa multiplying circuitry in the first and second modes, and the second product addition circuitry 310 in the third mode.

For example, the second product addition circuitry 310 may pair together the products that were determined using the second mantissa multiplying circuitry 108, and sum the two values within each pair of products to produce a respective intermediate sum value; thus overall giving half as many intermediate sum values as there were products to be added. These intermediate sum values are then routed to the first product addition circuitry 108 via the format multiplexer 390, where they are all added together to produce the output value of the multiplication unit 202. E.g. if in the third mode there are eight pairs of input values resulting in eight products (four pairs of products), the second product addition circuitry 310 may add together the products within each pair of products to produce a respective intermediate summed value—i.e. a total of four intermediate summed values, one from each pair of products. The first product addition circuitry 206 (which in the FP32 mode sums four partial products), then sums the intermediate summed values to produce a single summed output value. In some embodiments, this value is then normalised using normalisation circuitry.

FIG. 4 illustrates the addition unit 204. The addition unit 204 comprises exponent comparing circuitry 418, mantissa shifting circuitry 420, and mantissa adding circuitry 422. The addition unit 204 may be arranged to receive as input values: the output value of the multiplier unit 202, and at least one other value. These are the addends to the addition operation performed by the addition unit 204. By way of example, the at least one other value could comprise the output of another instance of the multiplier unit 202, so as to add together the outputs of two (or more) multiplier units 202. For example, an instance of the addition unit 204 may be used to implement the first (+) in FIG. 5, or a final stage of the summing done by the first (+) in FIGS. 6 and 7. As another example, the other value may comprise a value from an accumulator register. For example an instance of the addition unit 204 may be used to implement the second (+) in FIGS. 5 to 7.

In operation, the exponent comparing circuitry of the addition unit 204 compares the exponents of the two or more values that are input to the addition unit 204, and based on this determines which is the largest, and the distance (difference) of each other exponent to the largest exponent. If there are only two addends, this could be done using simple comparing circuitry such as of the design described in relation to FIG. 9. Alternatively if there are more than two addends, the comparing of the exponents could be done, for example, using sorting circuitry of a design as described in relation to FIG. 11 (with the appropriate number of layers for the number of addends), or using sorting circuitry of a design as described in relation to FIG. 13.

Once the largest exponent and the distances of the other exponent(s) are determined, the shifting circuitry 420 right shifts the corresponding mantissas of said other (i.e. the non-largest) exponent(s) right according to their distance, so as to align the mantissas according to bit significance. The mantissa adding circuitry 422 then adds the shifted mantissas to produce the mantissa of the output of the addition unit 204. The exponent of the output value is the largest exponent as determined by the exponent comparing circuitry 418.

It will be appreciated that the above embodiments have been described by way of example only.

More generally, according to one aspect disclosed herein there is provided logic circuitry for multiplying floating point numbers, each floating point number comprising a mantissa and an exponent. The logic circuitry comprises multiplication logic and addition logic. The multiplication logic includes: first mantissa multiplying circuitry comprising at least four multiplier sub-units, second mantissa multiplying circuitry separate from the first mantissa multiplying circuitry. The addition logic comprises at least first product addition circuitry. The logic circuitry is configured so as: I) in a first mode, to perform a multiplication to determine a product of two input values as an output value, each of the two input values having a first, higher precision number format, wherein the multiplication in the first mode includes: using each of the sub-units of the first mantissa multiplying circuitry to calculate a different partial product of the mantissas of the two input values, and using the first product addition circuitry to determine the product of the two input values by combining the partial products of the mantissas; II) in a second mode, to perform multiplications to determine a respective product of each of four pairs of input values, each input value of the four pairs having a second, intermediate precision number format, wherein the multiplications in the second mode include: using each of the multiplication sub-units of the first mantissa multiplying circuitry to multiply the mantissas of a different respective one of the pairs to calculate a respective mantissa product; and III) in a third mode, to perform multiplications to determine a respective product of each of a plurality of pairs of input values, each input value of said plurality of pairs having a third, lower precision number format, wherein the multiplications in the third mode include: using the second mantissa multiplying circuitry to multiply the mantissas of each pair to generate a respective mantissa product for each pair.

In embodiments, the multiplication logic may further comprise exponent addition circuitry comprising at least one exponent adding circuit; wherein the logic circuitry may be configured so as: I) in the first mode the multiplication includes: using the exponent addition circuitry to add together the exponents of the two input values; II) in the second mode the multiplications include: using the exponent addition circuitry to add the exponents of each pair to generate a respective exponent value for each pair; and III) in the third mode, the multiplications include: using the exponent addition circuitry to add the exponents of each pair to generate a respective exponent value for each pair.

In embodiments, the exponent addition circuitry may comprise a first exponent adding circuit and second exponent adding circuit separate from the first exponent adding circuit, wherein the first exponent adding circuit may be used to perform the exponent adding in the first mode but not in the second mode nor the third mode, and wherein the second exponent adding circuit may be used to perform at least some of the adding of the exponents in the second mode and in the third mode but not in the first mode.

In other embodiments, the exponent addition circuitry may comprise a shared exponent adding circuit used in all three modes.

In embodiments, the logic circuitry may be configured so as in the second mode, to use the addition logic to determine a sum of the products of the four pairs as the output value.

In embodiments, the logic circuitry may be configured so as in the second mode, to perform the determination of the sum of said four pairs using the first product addition circuitry.

In embodiments, the logic circuitry may be configured so as in the third mode, to use the addition logic to determine a sum of the products of the plurality of pairs as the output value.

In embodiments, the logic circuitry may be configured so as in the third mode, to perform the determination of the sum of said plurality of pairs at least partially using the first product addition circuitry.

In embodiments, the addition logic may comprise second product addition circuitry separate from the product addition circuitry, wherein the logic circuitry may be configured so as in the second mode to perform the determination of the sum of said plurality of pairs at least partially using the second product addition circuitry.

In embodiments, in order to perform the determination of the sum of said plurality of pairs in the third mode: the second product addition circuitry may perform pairwise summations of the products of each respective pair of the plurality of pairs, resulting in four summed product values; and the first product addition circuitry may determine a sum of the four summed product values output from the second product addition circuitry as the output value of the multiplication unit.

In embodiments, the addition logic may comprise exponent sorting circuitry. The logic circuitry may be configured so as: I) in second mode, to add a set of second addends comprising at least the products of the four pairs, including by: using the exponent sorting circuitry to sort the exponents of the second addends, in order to align the mantissas of the second addends according to bit significance and add the aligned mantissas; and II) in the third mode, to add a set of third addends comprising at least the products of said plurality of pairs, including by: using at least part of the same exponent sorting circuitry as used in the second mode to sort the exponents of the third addends, in order to align the mantissas of the third addends according to bit significance and add the aligned mantissas.

In embodiments, the addition logic may comprise exponent comparing circuitry separate to said exponent sorting circuitry, and the logic circuitry may be configured so as in the first mode, to add a set of first addends comprising the output value and at least one other value, the set of first addends being a pair of addends or at most a smaller set than each of the set of second addends and the set of third addends. The adding of the first set of addends may include: using the separate exponent comparing circuitry, and not the exponent sorting circuitry used in the second and third modes, to compare the exponents of the first addends in order to align the mantissas of the first addends according to bit significance and add the aligned mantissas.

In embodiments, the logic circuitry may be configured so as in the first mode, to add a set of first addends comprising the output value and at least one other value, including by: using at least part of the same exponent sorting circuitry as used in the second and third modes to sort the exponents of the first addends, in order to align the mantissas of the first addends according to bit significance and add the aligned mantissas.

In embodiments, the first product addition circuitry may include shifting circuitry and mantissa adding circuitry. In the first mode, the multiplying may include using the shifting circuitry of the first product addition circuitry to align the partial products according to bit significance, and using the mantissa adding circuitry of the first product addition circuitry to add together the aligned partial products to produce an output product.

In embodiments, in the second mode, the determining of the sum may include summing the mantissas of the four products using the same mantissa adding circuitry as used to sum the partial products in in the first mode.

In embodiments, the first product multiplying circuitry may further include exponent sorting circuitry. The logic circuitry may be operable in a fixed-shift mode in the first mode and a variable shift mode in the second mode and the third mode, wherein the first, high precision, number format has a first number of mantissa bits, and wherein in the first mode the first number of mantissa bits is bisected into a most significant portion and a least significant portion, and each of the four multiplier sub-units determines the partial product of a different combination of the most and least significant portions of the mantissas of the two input values. In the first mode, the mantissa shifting circuitry may perform the aligning of the partial products according to bit significance by: i) shifting the partial product of the most significant portions of the mantissas by a shift of 0 bits, ii) shifting the partial product of the least significant portions of the mantissas in the direction of lower bit significance by a shift of the first number of mantissa bits, and iii) shifting the two partial products between most significant and least significant portions of the mantissas in the direction of lower bit significance by a shift of half of the first number of mantissa bits. In the second mode, the mantissa shifting circuitry may shift the mantissas of the products according to exponent value received from the second exponent addition circuitry by: i) comparing, by the exponent sorting circuitry, the product exponent values for each pair of the four pairs to determine the highest exponent value, ii) determining, by the first exponent sorting circuitry, the difference between each product exponent value and the highest exponent value, and iii) shifting each mantissa product in the direction of lower bit significance by a number of bits corresponding to the difference between the respective product exponent value and the highest exponent value. In the third mode, the mantissa shifting circuitry may shift the mantissas of the four summed product values according to their respective exponent values received from the second exponent addition circuitry by: i) comparing, by the exponent sorting circuitry, the product exponent values for each pair of the four summed product values to determine the highest exponent value, ii) determining, by the first exponent sorting circuitry, the difference between each summed product exponent value and the highest exponent value; and iii) shifting each mantissa product of each summed product value in the direction of lower bit significance by a number of bits corresponding to the difference between the respective product exponent value and the highest exponent value.

In embodiments, the multiplication logic and first product addition circuitry may be comprised by a multiplication unit, said output value being an output of the multiplication unit. The addition logic may further comprise at least one separate addition unit arranged to sum a set of addend values in order to generate a summed value, the set of addend values comprising the output value of the multiplication unit and at least one other value.

In embodiments, the addition unit may comprise exponent comparing circuitry, mantissa shifting circuitry, and mantissa addition circuitry.

In embodiments, the addition unit may be configured to perform the adding of the output value to the at least one other value by: i) comparing, by the exponent comparing circuitry of the addition unit, the exponent of the output value of the multiplication unit with the exponent of the at least one other value in order to determine the highest exponent; ii) determining, by the exponent comparing circuitry of the addition unit, the difference between the exponents of each of the addend values and the highest exponent; iii) shifting, by the mantissa shifting circuitry of the addition unit, the mantissas of each addend value in the direction of lower bit significance by a number of bits corresponding to the respective difference between the exponent of the addend value and the highest exponent to generate a shifted mantissa for each addend value; and iv) adding, by the mantissa addition circuitry, the shifted mantissas to generate the summed value.

In embodiments, the addition unit may be used in all three modes.

In embodiments, the logic circuitry may comprise a further instance of the multiplication unit, and the at least one other value may comprise the output of the other instance of the multiplication unit.

In embodiments, said at least one other value may comprise a current value in an accumulator register. The current value in the accumulator may comprise the output value of a previous operation performed by the multiplication unit or an accumulated sum of a plurality of previous operations performed by the multiplication unit. The addition unit may be arranged to overwrite the current value in the accumulator register with the summed value.

In embodiments, the logic circuitry may comprise normalisation circuitry arranged to normalise the output value before it is input to the addition unit.

In embodiments, the logic circuitry may comprise normalisation circuitry arranged to normalise the summed value.

In embodiments, the logic circuitry may be arranged to be used to perform matrix multiplication.

In embodiments, said plurality of pairs of the third mode may be eight pairs.

In embodiments, the first number format may be 32 bits in length.

In embodiments, in the first number format the mantissa may be 24 bits in length.

In embodiments, in the first number format the mantissa may be 12 bits in length.

In embodiments, the second number format may be 16 bits in length.

In embodiments, in the second number format the mantissa may be 11 bits in length.

In embodiments, in the second number format the mantissa may be 8 bits in length.

In embodiments, the third number format may be 8 bits in length.

In embodiments, in the third number format the mantissa may be 2, 3 or 4 bits in length.

According to another aspect disclosed herein, there is provided a processor comprising the logic circuitry previously described.

In embodiments, the multiplication may be triggered by execution of an opcode of an individual machine code instruction, and the input values may be specified by source operands of the machine code instruction.

In embodiments, the mode may be specified by an operand or the opcode of the machine code instruction.

In embodiments, the mode may be specified by a control value in a control register written to by a separate machine code instruction.

In embodiments, the addition may be also triggered by the same individual machine code instruction as the multiplication.

In embodiments, the previous operation may be triggered by a previous instance of said machine code instruction, or each of the previous operations may be triggered by a respective previous instance of said machine code instruction.

In embodiments, the processor may be programmed to use the logic circuitry to perform the multiplication as part of a machine learning algorithm.

In embodiments, the processor may be programmed to use the logic circuitry to perform the multiplication and addition as part of a machine learning algorithm.

According to another aspect disclosed herein there may be provided a corresponding method of operating the logic circuitry of any embodiment disclosed herein.

According to a further aspect disclosed herein, there is provided value comparing circuitry, configured to take as input a plurality of values. Said plurality of values are divided among at least a first group of values and a second group of values. The value comparing circuitry comprises first comparing circuitry, configured to determine the largest value in the first group, and for each other value in the first group to determine the difference between that other value and the largest value in the first group. It further comprises second comparing circuitry, configured to determine the largest value in the second group, and for each other value in the second group to determine the difference between that other value and the largest value in the second group, and third comparing circuitry. The third comparing circuitry is configured to output an indication of whether the largest value in the first group is larger than the largest value in the second group. The value comparing circuitry also comprises first difference calculating circuitry, configured to determine the difference between each value in the first group and the largest value in the second group, second difference calculating circuitry configured to determine the difference between each value of the second group and the largest value in the first group; and multiplexing circuitry. The multiplexing circuitry is configured so that when the indication is that the largest value in the first group is larger than the largest value in the second group, the multiplexing circuitry outputs the differences from the first comparing circuitry and the second difference calculating circuitry, and when the indication is that the largest value in the first group is not larger than the largest value in the second group, the multiplexing circuitry outputs the differences from the second group comparing circuitry and the first difference calculating circuitry.

In embodiments, the value comparing circuitry may be operatively coupled to a shifting circuit, wherein each of said plurality of values is an exponent value of a respective floating point number, and each floating point number comprises also a respective mantissa. For each floating point number, the shifting circuit shifts the bits of the respective mantissa in the direction of lower significance by the respective output difference from the value comparing circuitry corresponding to the difference between the respective exponent value of the floating point number and the largest exponent value.

In embodiments, the value comparing circuitry may be operatively coupled to addition circuitry, which takes as an input for each value of the plurality of values the respective mantissa shifted by the shifting circuit, and computes a sum of these inputs.

In embodiments, each of the floating point numbers may be 16 bits in length.

In embodiments, the plurality of values may be eight values, and the first group of values and the second group of values may each consist of four values.

According to a further aspect disclosed herein, there is provided a processor comprising the value comparing circuitry, wherein the processor is programmed to use the addition circuitry as part of a matrix multiplication process.

In embodiments, the processor is programmed to use the value comparing circuitry as part of a machine learning algorithm.

Other variants and applications of the disclosed techniques may become apparent to a person skilled in the art once given the disclosure herein. The scope of the present disclosure is not limited by the described embodiments but only by the accompanying claims.

1. A processor configured to multiply floating point numbers, the processor comprising:
multiplication logic comprising first mantissa multiplying circuitry, having a plurality (N) of multiplier sub-units, wherein N is an integer greater than three, and second mantissa multiplying circuitry separate from the first mantissa multiplying circuitry; and
addition logic including first product addition circuitry;
wherein the processor is configured to operate in a first mode, a second mode, and a third mode:
in the first mode, generate a first product of a first input value and a second input value, both the first input value and the second input value having a first, higher precision number format, wherein generating the first product includes: using the plurality of multiplier sub-units to calculate a plurality of different partial products of mantissas of the first input value and the second input value, and using the first product addition circuitry to determine the first product by combining the plurality of different partial products;
in the second mode, generate a first plurality of products for a first plurality of pairs of input values, each input value of first plurality of pairs of input values having a second, intermediate precision number format, wherein generating the first plurality of products includes: using the plurality of multiplier sub-units to calculate a first plurality of mantissa products from the first plurality of pairs of input values; and
in the third mode, generate a second plurality of products for a second plurality of pairs of input values, each input value of the second plurality of pairs of input values having a third, lower precision number format, wherein generating the second plurality of products includes: using the second mantissa multiplying circuitry to calculate a second plurality of mantissa products from the second plurality of pairs of input values.

2. The processor of claim 1, wherein the multiplication logic further comprises exponent addition circuitry; wherein the processor is configured to:
in the first mode: use the exponent addition circuitry to add exponents of the first input value and the second input value;
in the second mode: use the exponent addition circuitry to add exponents of each pair of the first plurality of pairs of input values to generate first plurality of exponent values; and
in the third mode: use the exponent addition circuitry to add exponents of each pair of the second plurality of pairs of input values to generate a second plurality of exponent values.

3. The processor of claim 2, wherein the exponent addition circuitry comprises a first exponent adding circuit and a second exponent adding circuit separate from the first exponent adding circuit, wherein the first exponent adding circuit is configured to perform exponent adding in the first mode but not in the second mode nor in the third mode, and wherein the second exponent adding circuit is configured to perform at least some exponent adding in the second mode and in the third mode but not in the first mode.

4. The processor of claim 1, configured to, in the second mode, use the first product addition circuitry to determine a sum of the second plurality of products to generate an output value.

5. The processor of claim 1, further comprising second product addition circuitry separate from the first product addition circuitry, the processor configured to, in the third mode, use the addition logic to determine a sum of the second plurality of products to generate an output value, including:
the second product addition circuitry performing pairwise summations of the second plurality of products, resulting in four summed product values; and
the first product addition circuitry determining a sum of the four summed product values as the output value.

6. The processor of claim 1, wherein the addition logic further includes exponent sorting circuitry, and wherein the processor is configured to:
in the second mode, add a first set of addends comprising at least the first plurality of products, including by: using the exponent sorting circuitry to sort exponents of the first set of addends, to create first aligned mantissas of the first set of addends according to bit significance and add the first aligned mantissas;
in the third mode, add a second set of addends comprising at least the second plurality of products, including by: using at least a same part of the exponent sorting circuitry as used in the second mode to sort exponents of the second set of addends, to create second aligned mantissas of the second set of addends according to bit significance and add the second aligned mantissas.

7. The processor of claim 6, wherein the addition logic further includes exponent comparing circuitry separate to the exponent sorting circuitry, and wherein the processor is configured to:
in the first mode, add a third set of addends comprising an output value of the multiplication logic and at least one other value, the third set of addends being a pair of addends or at most a smaller set than each of the first set of addends and the second set of addends, wherein adding the third set of addends includes: using the exponent comparing circuitry, and not the exponent sorting circuitry, to compare exponents of the third set of addends to create third aligned mantissas of the third set of addends according to bit significance and add the third aligned mantissas.

8. The processor of claim 1, wherein the first product addition circuitry includes shifting circuitry and mantissa adding circuitry, and wherein the processor is configured to:
in the first mode, use the shifting circuitry to create aligned partial products according to bit significance and use the mantissa adding circuitry of the first product addition circuitry to add the aligned partial products to produce an output product.

9. The processor of claim 8, wherein the processor is configured to:
in the second mode, sum mantissas of the products of the first input value and the second input value using the mantissa adding circuitry.

10. The processor of claim 1, wherein the multiplication logic and the first product addition circuitry are included in a first multiplication unit; and wherein the addition logic further comprises an addition unit configured to sum a set of addend values to generate a summed value, the set of addend values comprising an output of the first multiplication unit and at least one other value.

11. The processor of claim 10, wherein the at least one other value comprises a current value in an accumulator register, the current value in the accumulator register comprising a previous output value of a previous operation performed by the first multiplication unit or an accumulated sum of a plurality of previous operations performed by the first multiplication unit, wherein the addition unit is arranged to overwrite the current value in the accumulator register with the summed value.

12. The processor of claim 10, further comprising normalisation circuitry arranged to normalise an output value before the output value is input to the addition unit.

13. The processor of claim 10, further comprising normalisation circuitry arranged to normalise the summed value.

14. The processor of claim 10, comprising a second multiplication unit, wherein the at least one other value comprises an output of the first multiplication unit.

15. Value comparing circuitry, configured to take as input a plurality of values, the plurality of values being divided among at least a first group of values and a second group of values; the value comparing circuitry comprising:
first comparing circuitry configured to determine a largest value in the first group, and to determine a first set of differences between the largest value in the first group and other values in the first group;
second comparing circuitry configured to determine a largest value in the second group, and to determine a second set of differences between the largest value in the second group and other values in the second group;
third comparing circuitry configured to output an indication of whether the largest value in the first group is larger than the largest value in the second group;
first difference calculating circuitry configured to determine a third set of differences between each value in the first group and the largest value in the second group;
second difference calculating circuitry configured to determine a fourth set of differences between each value of the second group and the largest value in the first group; and
multiplexing circuitry configured to:
output the first set of differences from the first comparing circuitry and the fourth set of differences from the second difference calculating circuitry in response to the indication indicating that the largest value in the first group is larger than the largest value in the second group, and
output the second set of differences from the second comparing circuitry and the third set of differences from the first difference calculating circuitry in response to the indication indicating that the largest value in the first group is not larger than the largest value in the second group.

16. The value comparing circuitry of claim 15, operatively coupled to a shifting circuit, wherein each value of the plurality of values is an exponent value of a respective floating point number of a plurality of floating point numbers, each floating point number of the plurality of floating point numbers comprising also a respective mantissa; and
for each floating point number, the shifting circuit is configured to shift bits of the respective mantissa in a direction of lower bit significance by a respective output difference from the value comparing circuitry corresponding to a difference between a respective exponent value and a largest exponent value.

17. The value comparing circuitry of claim 16, wherein the value comparing circuitry is operatively coupled to addition circuitry, which takes as inputs for each value of the plurality of values the respective mantissa shifted by the shifting circuit and computes a sum of the inputs.

18. The value comparing circuitry of claim 17, wherein each of the floating point numbers is 16 bits in length.

19. The value comparing circuitry of claim 17, wherein the value comparing circuitry is included in a processor, and wherein the processor is programmed to use the addition circuitry as part of a matrix multiplication process.

20. The value comparing circuitry of claim 15, wherein the value comparing circuitry is included in a processor, and wherein the processor is programmed to use the value comparing circuitry as part of a machine learning algorithm.
